(19) United States
(12) Patent Application Publication
(10) Pub. No.: US 2024/0368023 A1
(43) Pub. Date: Nov. 7, 2024

(54) GLASS FOR CHEMICAL STRENGTHENING, CHEMICALLY STRENGTHENED GLASS, ELECTRONIC DEVICE, METHOD FOR MANUFACTURING CHEMICALLY STRENGTHENED GLASS

(71) Applicant: AGC Inc., Tokyo (JP)

(72) Inventors: Hiroki TAKAHASHI, Tokyo (JP); Atsuto HASHIMOTO, Tokyo (JP); Kaname SEKIYA, Tokyo (JP); Seiji INABA, Tokyo (JP)

(73) Assignee: AGC Inc., Tokyo (JP)

(21) Appl. No.: 18/650,183

(22) Filed: Apr. 30, 2024

(30) Foreign Application Priority Data
May 1, 2023 (JP) 2023-075767
Apr. 25, 2024 (JP) 2024-071340

(51) Int. Cl. C03C 3/097; C03C 3/095

(52) U.S. Cl. CPC C03C 3/097; C03C 3/095

(57) ABSTRACT

The present invention relates to a glass for chemical strengthening, including: in terms of mole percentage based on oxides, 50% or more of SiO₂; 0% to 10% of B₂O₃; 1% to 30% of Al₂O₃; 0% to 10% of P₂O₅; 0% to 10% of Y₂O₃; 0% to 25% of Li₂O; 0% to 25% of Na₂O; 0% to 25% of K₂O; 0% to 10% of MgO; 0% to 10% of CaO; 0% to 10% of SrO; 0% to 10% of BaO; 0% to 10% of ZnO; 0% to 5% of ZrO₂; 0% to 5% of TiO₂; 0% to 5% of SnO₂; and 0% to 0.5% of Fe₂O₃, in which a ratio (R₂O/Al₂O₃) of a total content of Li₂O, Na₂O, and K₂O to a content of Al₂O₃ satisfies the following Expression: 0.8≤(R₂O/Al₂O₃)≤30.

### CROSS-REFERENCE TO RELATED APPLICATIONS

This application is based on and claims priority from Japanese Patent Application No. 2023-075767 filed on May 1, 2023 and Japanese Patent Application No. 2024-071340 filed on Apr. 25, 2024, the entire content of which is incorporated herein by reference.

### TECHNICAL FIELD

The present invention relates to a glass for chemical strengthening, a chemically strengthened glass, an electronic device, and a method for manufacturing a chemically strengthened glass.

### BACKGROUND ART

A chemically strengthened glass is used for a cover glass or the like of a mobile terminal. The chemically strengthened glass is one in which a glass is brought into contact with a molten salt composition such as sodium nitrate to cause ion exchange between an alkali metal ion contained in the glass and an alkali metal ion contained in the molten salt composition and having a larger ionic radius, and a compressive stress layer is formed on a surface portion of the glass.

Patent Literature 1 discloses that the lower a surface resistivity of a chemically strengthened cover glass, the higher durability of an antifouling layer formed on the cover glass. The surface resistivity is correlated with an electrical conductivity of a glass surface, and a state where the surface resistivity is low indicates that the electrical conductivity of the glass surface is high. That is, increasing the electrical conductivity of the glass surface improves the durability of the antifouling layer.

### CITATION LIST

### Patent Literature

Patent Literature 1: WO2021/010376

### SUMMARY OF INVENTION

In recent years, an “abnormal emission phenomenon” in which a part of an organic EL display (OLED) unintentionally and continuously emits light has become a problem in an electronic device such as a mobile terminal.

The abnormal emission phenomenon is considered to be correlated with electrostatic charge caused by rubbing the display for a long time.

Patent Literature 1 focuses on a relationship between the surface resistivity of the chemically strengthened glass and adhesiveness of the antifouling layer formed on the surface of the chemically strengthened glass, and does not discuss the abnormal emission phenomenon by any means.

An object of the present invention is to provide a glass for chemical strengthening and a chemically strengthened glass that can prevent an abnormal emission phenomenon of a display when used as a cover glass of a display of an electronic device or the like.

The present inventors consider that the abnormal emission phenomenon is correlated with a tendency for charge transfer to occur due to electrostatic charge, and find that an electrical resistance (hereinafter, sometimes simply referred to as “resistance”) of a glass is correlated with occurrence of the abnormal emission phenomenon. More specifically, the inventors find that the abnormal emission phenomenon is prevented easily as the electrical resistance of the glass becomes relatively high, leading to the completion of the present invention.

That is, the present disclosure relates to the followings.
1. A glass for chemical strengthening, including:
   in terms of mole percentage based on oxides,
   50% or more of SiO₂;
   0% to 10% of B₂O₃;
   1% to 30% of Al₂O₃;
   0% to 10% of P₂O₅;
   0% to 10% of Y₂O₃;
   0% to 25% of Li₂O;
   0% to 25% of Na₂O;
   0% to 25% of K₂O;
   0% to 10% of MgO;
   0% to 10% of CaO;
   0% to 10% of SrO;
   0% to 10% of BaO;
   0% to 10% of ZnO;
   0% to 5% of ZrO₂;
   0% to 5% of TiO₂;
   0% to 5% of SnO₂; and
   0% to 0.5% of Fe₂O₃, in which
   a ratio (R₂O/Al₂O₃) of a total content of Li₂O, Na₂O, and K₂O to a content of Al₂O₃ satisfies the following Expression (A):

0.8≤(R₂O/Al₂O₃)≤30 (A).
2. The glass for chemical strengthening according to 1, further including:
   in terms of mole percentage based on oxides,
   7% to 12% of Li₂O;
   1.5% to 6% of Na₂O; and
   0% to 1.5% of K₂O.
3. A chemically strengthened glass, in which
   K-DOL defined below is 4.2 μm or more, and
   a surface resistivity is 11 [log Ω/sq] or more,
   K-DOL (μm): value of depth from glass surface of compressive stress layer caused by potassium ion.
4. A chemically strengthened glass, in which
   K-CSarea defined below is 4000 Pa·m or more, and
   a surface resistivity is 11 [logQ/sq] or more,
   K-CSarea (Pa·m): product of K-CS₀ and K-DOL,
   K-CS₀ (MPa): compressive stress value on glass surface measured by film stress measurement,
   K-DOL (μm): value of depth from glass surface of compressive stress layer caused by potassium ion.
5. The chemically strengthened glass according to 4, in which
   the K-CS₀ is 800 MPa or more.
6. A chemically strengthened glass, in which
   a ratio of K₂O@3 μm, which is a concentration of K₂O at a depth of 3 μm from a glass surface, to K₂O@center, which is a concentration of K₂O at a sheet thickness central portion, is 5.5 or more, and
   a surface resistivity is 11 [log Ω/sq] or more.
7. A chemically strengthened glass, in which
   a ratio of Li₂O@5 μm, which is a concentration of Li₂O at a depth of 5 μm from a glass surface, to Li₂O@center, which is a concentration of Li₂O at a sheet thickness central portion, is 0.85 or less, and
   a surface resistivity is 11 [log Ω/sq] or more.
8. The chemically strengthened glass according to any one of 3 to 7, in which
   a value of Y defined below is 9.4 or more,
   Y=0.00018x₁+4.319×10⁻⁷x₂+8.5,
   x₁: product K-CSarea (Pa·m) of K-CS₀ and K-DOL,
   x₂: product Na-CSarea (Pa·m) of Na-CS₀ and Na-DOL,
   K-CS₀ (MPa): compressive stress value on glass surface measured by film stress measurement,
   K-DOL (μm): value of depth from glass surface of compressive stress layer caused by potassium ion,
   Na-CSo (MPa): compressive stress value on glass surface measured by scattered light photoelastic stress meter, Na-DOL (μm): value of depth from glass surface of compressive stress layer caused by Na ion.
9. An electronic device, including:
   the glass for chemical strengthening according to 1 or 2, or the chemically strengthened glass according to any one of 3 to 8.
10. A method for manufacturing a chemically strengthened glass, the method including:
   a first ion exchange treatment of bringing a glass for chemical strengthening into contact with a first molten salt composition; and
   a second ion exchange treatment of bringing the glass for chemical strengthening into contact with a second molten salt composition after the first ion exchange treatment, in which
   the second molten salt composition includes 94 mass % or more of KNO₃ and less than 300 mass ppm of lithium ions.
11. The method for manufacturing a chemically strengthened glass according to 10, in which
   a temperature of the second molten salt composition in the second ion exchange treatment is 380° C. to 450° C., and a time for bringing the glass for chemical strengthening into contact with the second molten salt composition is 60 minutes or more.
12. The method for manufacturing a chemically strengthened glass according to 10 or 11, in which
   the second molten salt composition includes 0 mass % to 5 mass % of NaNO₃.
13. A method for manufacturing a chemically strengthened glass, the method including:
   performing an ion exchange treatment on a glass for chemical strengthening to obtain a chemically strengthened glass, in which
   the chemically strengthened glass having K-DOL defined below of 4.2 μm or more and a surface resistivity of 11 [log Ω/sq] or more is obtained,
   K-DOL (μm): value of depth from glass surface of compressive stress layer caused by potassium ion.
14. A method for manufacturing a chemically strengthened glass, the method including:
   performing an ion exchange treatment on a glass for chemical strengthening to obtain a chemically strengthened glass, in which
   the chemically strengthened glass having K-CSarea defined below of 4000 Pa·m or more and a surface resistivity of 11 [log Ω/sq] or more is obtained,
   K-CSarea (Pa·m): product of CS₀ and K-DOL,
   CS₀ (MPa): compressive stress value on glass surface,
   K-DOL (μm): value of depth from glass surface of compressive stress layer caused by potassium ion.

The present invention can provide a chemically strengthened glass that can prevent an abnormal emission phenomenon of a display when used as a cover glass of a display of an electronic device or the like, and a glass for chemical strengthening that can easily obtain a chemically strengthened glass having high resistance by chemical strengthening.

### BRIEF DESCRIPTION OF DRAWINGS

FIG. 1 is a diagram schematically illustrating an abnormal emission phenomenon.

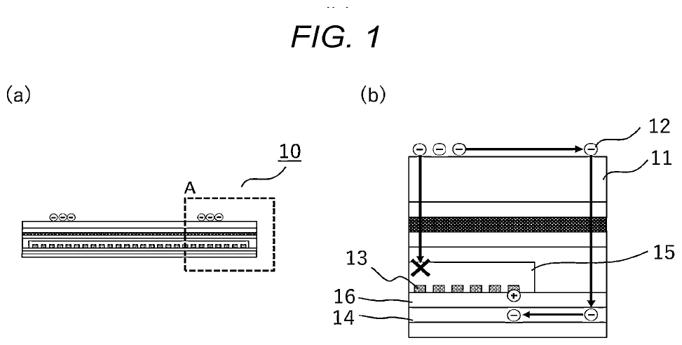

FIG. 2 is a diagram showing a relationship between a surface resistivity and a volume resistivity.

FIG. 3 is a diagram showing a relationship between a value of Y and the volume resistivity (actually measured value).

FIG. 4 is a diagram showing K₂O profiles of surface layers.

### DESCRIPTION OF EMBODIMENTS

In the present description, “to” indicating a numerical range is used in a sense of including numerical values set forth before and after the “to” as a lower limit value and an upper limit value. In the present specification, a composition (content of each component) of a glass is expressed in terms of mol percentage based on oxides, unless otherwise specified, and mol % is simply expressed as “%”.

In the present specification, “not substantially contained” means that a component has a content equal to or less than an impurity level contained in raw materials and the like, that is, the component is not intentionally added. Specifically, a content is less than 0.1%, for example.

In the present specification, an “amorphous glass” refers to a glass in which a diffraction peak indicating a crystal is not observed by powder X-ray diffraction. A “crystallized glass” is obtained by subjecting the “amorphous glass” to a heat treatment to precipitate crystals, and contains crystals. In the present specification, the “amorphous glass” and the “crystallized glass” may be collectively referred to as the “glass”. The amorphous glass that becomes a crystallized glass by the heat treatment may be referred to as a “base glass of the crystallized glass”.

In the following, a “chemically strengthened glass” refers to a glass after a chemical strengthening treatment, and a “glass for chemical strengthening” refers to a glass before the chemical strengthening treatment.

### <Stress Measuring Method>

In recent years, a glass that undergoes chemical strengthening with two or more stages by exchanging a lithium ion inside the glass with a sodium ion (Li—Na exchange), and then exchanging the sodium ion inside the glass with a potassium ion (Na—K exchange) on a surface layer portion of the glass has become mainstream for a cover glass of a smartphone and the like.

In order to obtain a stress profile of such a chemically strengthened glass in a non-destructive manner, for example, a scattered light photoelastic stress meter (hereinafter, also abbreviated as SLP), a film stress measurement (hereinafter, also abbreviated as FSM), or the like may be used in combination.

In a method using the scattered light photoelastic stress meter (SLP), a compressive stress derived from the Li—Na exchange can be measured inside the glass at a distance of several tens of μm or more from a glass surface layer.

On the other hand, in a method of using the film stress measurement (FSM), the compressive stress derived from Na—K exchange can be measured in the glass surface layer portion, which is at a distance of several tens of μm or less from the glass surface (for example, WO2018/056121 and WO2017/115811).

Therefore, as the stress profile in the glass surface layer and an inner portion of the two-stage chemically strengthened glass, a combination of SLP information and FSM information is sometimes used.

In the present invention, the stress profile measured mainly by the scattered light photoelastic stress meter (SLP) is used. In the present specification, a compressive stress CS, a tensile stress CT, a depth of compressive stress layer DOC, or the like means a value in a SLP stress profile.

The scattered light photoelastic stress meter is a stress measuring device including: a polarization phase difference variable member that changes a polarization phase difference of laser light by one wavelength or more with respect to a wavelength of the laser light; an imaging element that acquires a plurality of images by imaging, a plurality of times at predetermined time intervals, scattered light emitted when the laser light having the variable polarization phase difference is incident on a strengthened glass; and a calculation unit that measures a periodic luminance change of the scattered light using the plurality of images, calculates a phase change of the luminance change, and calculates stress distribution in a depth direction from a surface of the strengthened glass based on the phase change.

A method for measuring the stress profile using the scattered light photoelastic stress meter includes a method described in WO2018/056121. Examples of the scattered light photoelastic stress meter include SLP-1000 and SLP-2000 manufactured by Orihara industrial Co., Ltd. Combining attached software SlpIV_up3 (Ver.2019.01.10.001) with these scattered light photoelastic stress meters enables highly accurate stress measurement.

### <K-DOL, K-CS₀, K-CSarea>

“K-DOL” in the present specification is the depth of compressive stress layer derived from Na—K exchange and caused by a potassium ion in the glass surface layer portion which is at a distance of several tens of μm or less from the glass surface. K-DOL is a numerical value that can be approximated by the depth at which a concentration of the potassium ion becomes equal to a concentration of the potassium ion at a sheet thickness central portion. K-DOL can also be measured as a measurement limit value of the depth of compressive stress layer measured by the film stress measurement (FSM).
“K-CS₀” is a compressive stress value caused by the potassium ion at a depth of 0 μm measured by FSM.
“K-CSarea” is a product of K-CS₀ and K-DOL.

### <Na-DOL, Na-CS₀, Na-CSarea>

“Na-DOL” in the present specification is a depth of a compressive stress layer derived from Li—Na exchange and caused by the Na ion, inside the glass which is at a distance of several tens of μm or more from the glass surface layer. Na-DOL is a depth at which the compressive stress caused by the Na ion becomes 0.
“Na-CS₀” is a compressive stress value caused by the Na ion at the depth of 0 μm measured by SLP.
“Na-CSarea” is a product of Na-CS₀ and Na-DOL.

### <CTave>

“CTave” (MPa) in the present specification is obtained by the following expression. CTave is a value corresponding to an average value of a tensile stress, and is a value obtained by integrating a stress value of a tensile stress region and dividing the integrated value by a length of the tensile stress region.
CTave=ICT/L_{CT}
ICT: integrated value (Pa·m) of tensile stress
L_{CT}: sheet thickness direction length (μm) of tensile stress region

### <CSₓ>

“CSₓ” in the present specification is a compressive stress value (MPa) at a depth of x (μm) from the glass surface. This numerical value is a value measured by SLP.

<Concentration of K₂O, Concentration of Na₂O>

In the present specification, a concentration of K₂O and a concentration of Na₂O at a depth of x [μm] are measured by an electron probe micro analyzer (EPMA) in a cross section in a sheet thickness direction. The measurement by EPMA is specifically performed as follows, for example.

First, a glass sample is embedded with an epoxy resin and mechanically polished in a direction perpendicular to a first main surface and a second main surface opposite to the first main surface to prepare a cross section sample. A C coat is applied to the polished cross section, and measurement is performed using an EPMA (JXA-850OF manufactured by JEOL Ltd.). A line profile of an X-ray intensity of K₂O or NazO is obtained at intervals of 1 μm with an acceleration voltage of 15 kV, a probe current of 30 nA, and an integration time of 1000 msec./point. Regarding the obtained K₂O concentration profile or Na₂O concentration profile, an average count at the sheet thickness central portion (0.5×t)±25 μm (sheet thickness is t μm) is used as a base composition, and a count of an entire sheet thickness is calculated by proportionally converting the count into mol %.

### <Concentration of Li₂O>

In the present specification, a concentration of Li₂O at the depth of x (μm) is measured by a glow discharge optical emission spectroscopy (GD-OES) in the cross section in the sheet thickness direction. The measurement by GD-OES is specifically performed as follows, for example.

First, the glass sample is made clean by washing. Measurement is performed using a Marcus-type high-frequency glow discharge optical emission spectrometer (GD-Profiler 2, manufactured by HORIBA Co., Ltd.).

Emission spectra with respect to a sputtering time are obtained under conditions including a discharge condition of 40 W (constant power mode), an Ar pressure of 200 Pa, a discharge mode pulse sputtering mode (duty cycle 0.25 DS), and a discharge range of 4 mmo.

The obtained concentration of Li is normalized by a concentration in an unreinforced substrate and then proportionally converted to the concentration of Li₂O contained in the substrate. A discharge scar depth after the measurement is measured using a surface roughness meter, and the sputtering time is converted into a measured depth in 0.00025 μm increments. The profile is smoothed using a centered moving average method with a width of 0.25 μm.

### <Chemically Strengthened Glass>

The chemical strengthening treatment is a treatment in which by a method such as immersion in a molten solution of a metal salt (for example, sodium nitrate or potassium nitrate) containing a metal ion having a large ionic radius (typically, a sodium ion or a potassium ion), or applying or spraying the molten solution, the glass is brought into contact with the metal salt, and a metal ion having a small ionic radius (typically, a lithium ion or a sodium ion) in the glass is substituted with the metal ion having a large ionic radius (typically, the sodium ion or the potassium ion with respect to the lithium ion, and the potassium ion with respect to the sodium ion) in the metal salt.

<Relationship between Abnormal Emission Phenomenon and Electrical Resistance of Glass>

As described above, an “abnormal emission phenomenon” in which a part of a display unintentionally and continuously emits light has become a problem in an electronic device such as a mobile terminal. This phenomenon is known to occur particularly in an organic EL display using a polyimide substrate (PI-OLED). It is known that the abnormal emission phenomenon can typically occur after continuously rubbing the display of the electronic device with a finger for a long time. Light emission is likely to occur near edges (periphery) and holes of the display, and light emission lasts for a long time (about 1 day to 2 days in some cases) rather than for a short time.

Based on these matters, the inventors find that in order to prevent the abnormal emission phenomenon, it is effective to make an electrical resistance of a glass used for a cover glass relatively high. In addition, the inventors find that the electrical resistance of the chemically strengthened glass can be made relatively high by a chemical strengthening process, and the chemically strengthened glass having a high electrical resistance can be easily obtained by adjusting a glass composition to an appropriate range, leading to the completion of the present invention.

In the present specification, the electrical resistance of the cover glass is evaluated by a surface resistivity or a volume resistivity. Here, the surface resistivity is a value of a surface resistance per 1 cm² of the glass. A surface resistivity of a main surface of the glass correlates with the case of movement of charges in a direction parallel to the main surface, which means that the charges are hard to flow in the direction parallel to a direction of the main surface as the surface resistivity becomes higher. Therefore, the surface resistivity is a value that has almost no correlation with a sheet thickness of the glass. The volume resistivity is a volume resistance value per 1 cm₃ of the glass. The volume resistivity of the glass correlates with the ease of movement of the charges between one main surface and the other main surface opposite to the one main surface of the glass (hereinafter, sometimes simply referred to as the sheet thickness direction), which means that the charges are hard to flow in the sheet thickness direction as the volume resistivity becomes higher.

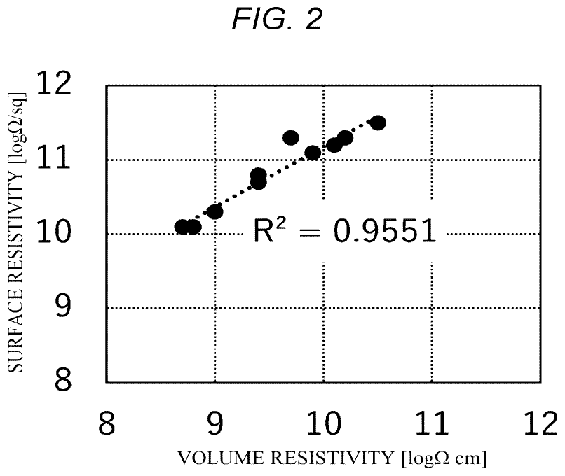

FIG. 2 shows a relationship between the surface resistivity and the volume resistivity of the chemically strengthened glass when sheet-shaped glasses for chemical strengthening having the same base composition and same sheet thickness are subjected to the chemical strengthening treatment under a plurality of different conditions.

It can first be seen from FIG. 2 that the chemical strengthening process can affect the electrical resistance of the chemically strengthened glass. That is, it can be seen that the electrical resistance of the chemically strengthened glass can be increased by appropriately controlling the conditions of the chemical strengthening process or properties of the chemically strengthened glass obtained thereby. As a result of studies by the inventors, it is considered that the following cases (I) and (II) contribute to increasing the electrical resistance of the chemically strengthened glass.
(I) In the vicinity of the glass surface, a plurality of different alkali metal ions are mixed in a nearly uniform ratio.
(II) In the vicinity of the glass surface, the alkali metal ions having a relatively large size are introduced by the chemical strengthening treatment.

In addition, FIG. 2 shows that there is a positive correlation between the surface resistivity and the volume resistivity. When the chemically strengthened glass has a relatively high resistance in the vicinity of the surface and charges move in the direction parallel to the direction of the main surface, the charges are difficult to move in the vicinity of the surface of the main surface, and it is considered that the charges bypass a portion relatively deep from the main surface. If the surface resistivity is measured in this case, it is considered that the charges pass through a high resistance portion twice, moving from the vicinity of the main surface to the deep portion, and returning from the deep portion to the vicinity of the main surface. Similarly, when the volume resistivity is measured, it is considered that the charges pass through the high resistance portion twice, passing through the high resistance portion in the vicinity of one main surface and the high resistance portion in the vicinity of the other main surface. From these, it can be described that there is a linear positive correlation between the surface resistivity and the volume resistivity. From these matters, it can be said that the chemically strengthened glass having a relatively high resistance can prevent the charges from moving in the direction parallel to the main surface of the display and in the sheet thickness direction, which contributes to preventing the abnormal emission phenomenon.

Hereinafter, embodiments of the present invention will be described in detail, but the present invention is not limited to the following embodiments, and can be freely modified and implemented without departing from the gist of the present invention. For example, for the plurality of embodiments described in the present specification, preferred aspects of each embodiment may be combined with each other, or a part of each embodiment may be replaced with a preferred aspect of another embodiment.

The glass for chemical strengthening according to the present embodiment includes glasses for chemical strengthening according to a first embodiment and a second embodiment described below.

### First Embodiment

The glass for chemical strengthening according to the first embodiment of the present invention includes:
in terms of mole percentage based on oxides,
50% or more of SiO₂;
0% to 10% of B₂O₃;
1% to 30% of Al₂O₃;
0% to 10% of P₂O₅;
0% to 10% of Y₂O₃;
0% to 25% of Li₂O;
0% to 25% of Na₂O;
0% to 25% of K₂O;
0% to 10% of MgO;
0% to 10% of CaO;
0% to 10% of SrO;
0% to 10% of BaO;
0% to 10% of ZnO;
0% to 5% of ZrO₂;
0% to 5% of TiO₂;
0% to 5% of SnO₂; and
0% to 0.5% of Fe₂O₃, in which
a ratio (R₂O/Al₂O₃) of a total content of Li₂O, Na₂O, and K₂O to a content of Al₂O₃ satisfies the following Expression (A).

0.8≤(R₂O/Al₂O₃)≤30 (A)

The glass for chemical strengthening according to the first embodiment has the above-described composition, so that the glass itself is likely to have a relatively high resistance, and it is easy to obtain a chemically strengthened glass having a high resistance when the glass is chemically strengthened.

From a viewpoint of increasing the surface resistivity and the volume resistivity, and from a viewpoint of introducing, into the glass, a compressive stress necessary to enhance a strength of the glass, the glass for chemical strengthening according to the first embodiment preferably contains 7% to 12% of Li₂O, 1.5% to 6% of Na₂O, and 0% to 1.5% of K₂O in terms of mole percentage based on oxides.

Hereinafter, a more preferable composition of the glass for chemical strengthening according to the first embodiment will be described in detail. Regarding the glass composition, a lower limit of a preferred content of a non-essential component is 0%.

In the glass for chemical strengthening according to the present embodiment, SiO₂ is a component for forming a glass network structure. SiO₂ is also a component that improves chemical durability.

A content of SiO₂ is 50% or more, preferably 52% or more, more preferably 56% or more, further preferably 60% or more, particularly preferably 64% or more, and most preferably 68% or more. On the other hand, in order to improve a meltability, the content of SiO2 is less than 75%, preferably 73% or less, more preferably 72% or less, further preferably 71% or less, particularly preferably 70% or less, and most preferably 69% or less.

B₂O₃ is a component that improves a chipping resistance of the glass for chemical strengthening or the chemically strengthened glass and improves the meltability, and may be contained. When B₂O₃ is contained, in order to improve the meltability, a content of B₂O₃ is preferably 0.5% or more, more preferably 1% or more, and further preferably 2% or more. On the other hand, if the content of B₂O₃ is too large, striae may occur during melting, or phase separation is likely to occur, and then a quality of the glass for chemical strengthening is likely to deteriorate, so that the content of B₂O₃ is preferably 10% or less. The content of B₂O₃ is more preferably 8% or less, further preferably 6% or less, and particularly preferably 4% or less.

Al₂O₃ is a component that increases a surface compressive stress caused by chemical strengthening and is essential.

A content of Al₂O₃ is 1% or more, preferably 3% or more, 5% or more, 7% or more, 9% or more, and 11% or more in order, more preferably 12% or more, further preferably 13% or more, particularly preferably 14% or more, and most preferably 15% or more. On the other hand, in order to prevent a devitrification temperature of the glass from becoming excessively high, the content of Al₂O₃ is 30% or less, preferably 27% or less, more preferably 24% or less, further preferably 21% or less, particularly preferably 19% or less, and most preferably 18% or less.

P₂O₅ is not essential, is a component that enlarges a compressive stress layer caused

by chemical strengthening, and may be contained. Since P₂O₅ is a component that can promote diffusion of potassium ions during the chemical strengthening treatment, it is preferable to contain P₂O₅ from a viewpoint of obtaining a chemically strengthened glass having a high resistance. P₂O₅ is also a component that can promote crystallization in a crystallized glass.

When P₂O₅ is contained, a content of P₂O₅ is preferably 0.5% or more, more preferably 1% or more, further preferably 1.5% or more, particularly preferably 2% or more, and most preferably 2.5% or more.

On the other hand, if the content of P₂O₅ is too large, phase separation is likely to occur during melting and an acid resistance is remarkably lowered, and thus the content of P₂O₅ is 10% or less, preferably 8% or less, more preferably 6% or less, further preferably 5% or less, particularly preferably 4% or less, and most preferably 3% or less.

Y₂O₃ is not essential, is a component that is effective in preventing fragments from scattering when the chemically strengthened glass is broken, and may be contained.

When Y₂O₃ is contained, a content of Y₂O₃ is preferably 0.5% or more, more preferably 1% or more, further preferably 1.5% or more, particularly preferably 2% or more, and most preferably 2.5% or more.

On the other hand, in order to prevent devitrification during melting, the content of Y₂O₃ is 10% or less, preferably 8% or less, more preferably 6% or less, further preferably 4% or less, particularly preferably 3.5% or less, and most preferably 3% or less.

Li₂O, Na₂O, and K₂O are components having an effect of increasing the surface resistivity and the volume resistivity, and an effect of adjusting ion exchange properties of the glass in order to appropriately introduce, into the glass, a compressive stress necessary to improve the strength of the glass. In the glass according to the present embodiment, from a viewpoint of increasing the surface resistivity and the volume resistivity and from a viewpoint of introducing the compressive stress by the chemical strengthening treatment, the total content of Li₂O, Na₂O, and K₂O is more than 0%, preferably 10% or more, more preferably 11% or more, further preferably 12% or more, particularly preferably 14% or more, and most preferably 16% or more. From a viewpoint of reducing devitrification properties during glass molding, the total content of Li₂O, Na₂O, and K₂O is preferably 35% or less, more preferably 30% or less, further preferably 25% or less, particularly preferably 20% or less, and most preferably 19% or less.

In the glass according to the present embodiment, the ratio (R₂O/Al₂O₃) of the total content of Li₂O, Na₂O, and K₂O to the content of Al₂O₃ satisfies the following Expression (A).

0.8≤(R₂O/Al₂O₃)≤30 (A)

(R₂O/Al₂O₃) satisfying the above-described Expression (A) means that the content of Al₂O₃ is relatively high or low with respect to a content of alkali metal oxides. Accordingly, an effect of improving the surface resistivity and the volume resistivity is achieved.

If (R₂O/Al₂O₃) satisfies the above-described Expression (A), (R₂O/Al₂O₃) is 0.8 or more, preferably 0.84 or more, more preferably 0.88 or more, further preferably 0.92 or more, particularly preferably 0.96 or more, and most preferably 1.0 or more. On the other hand, (R₂O/Al₂O₃) is 30 or less, preferably 25 or less, 20 or less, 10 or less, 5 or less, and 2 or less in order, more preferably 1.8 or less, further preferably 1.5 or less, and particularly preferably 1.0 or less.

Li₂O is a component that forms the compressive stress by ion exchange.

Li₂O is not essential, and when Li₂O is contained, a content of Li₂O is preferably 3% or more, more preferably 5% or more, further preferably 7% or more, even more preferably 8% or more, particularly preferably 9% or more, and most preferably 10% or more. On the other hand, in order to stabilize the glass, the content of Li₂O is 25% or less, preferably 22% or less, more preferably 20% or less, further preferably 18% or less, particularly preferably 16% or less, even more preferably 14% or less, and most preferably 12% or less.

Na₂O is a component that improves the meltability of the glass.

Na₂O is not essential, and when Na₂O is contained, a content of Na₂O is preferably 1% or more, more preferably 1.5% or more, further preferably 2% or more, even more preferably 3% or more, particularly preferably 4% or more, and most preferably 5% or more. If the content of Na₂O is too large, the chemical strengthening properties deteriorate, and thus the content of Na₂O is preferably 25% or less, more preferably 20% or less, further preferably 15% or less, particularly preferably 12% or less, even more preferably 10% or less, and most preferably 6% or less.

K₂O is not essential, is a component that lowers a melting temperature of the glass, and may be contained, like Na₂O.

When K₂O is contained, a content of K₂O is preferably 0.1% or more, more preferably 0.5% or more, further preferably 1% or more, particularly preferably 1.5% or more, and most preferably 2% or more. If the content of K₂O is too large, the chemical strengthening properties deteriorate or the chemical durability deteriorates, and thus the content of K₂O is preferably 10% or less, more preferably 8% or less, further preferably 6% or less, particularly preferably 5% or less, even more preferably 4% or less, and most preferably 1.5% or less.

In order to improve a meltability of a glass raw material, a total content (Na₂O+K₂O) of Na₂O and K₂O is preferably 2% or more, more preferably 3% or more, further preferably 4% or more, particularly preferably 5% or more, and most preferably 6% or more. Na₂O+K₂O is preferably 20% or less, more preferably 15% or less, further preferably 12% or less, particularly preferably 10% or less, and most preferably 8% or less.

BaO, SrO, MgO, CaO, and ZnO are components that improve the meltability of the glass, and may be contained. When containing any one or more of BaO, SrO, MgO, CaO, and ZnO, a total content thereof is preferably 0.5% or more, more preferably 1% or more, further preferably 1.5% or more, particularly preferably 2% or more, and most preferably 2.5% or more. On the other hand, from a viewpoint of keeping an ion exchange rate at or above a certain level, the above total content is preferably 10% or less, more preferably 8% or less, further preferably 7% or less, particularly preferably 6% or less, and most preferably 5% or less.

MgO is not essential, is a component that stabilizes the glass, and is also a component that enhances mechanical strength and chemical resistance, and thus it is preferable to contain MgO when the content of Al₂O₃ is low.

A content of MgO is preferably 0.5% or more, more preferably 1% or more, further preferably 2% or more, particularly preferably 3% or more, and most preferably 4% or more.

On the other hand, if too much MgO is added, viscosity of the glass is lowered, and devitrification or phase separation is likely to occur. The content of MgO is 10% or less, preferably 9% or less, more preferably 8% or less, further preferably 7% or less, particularly preferably 6% or less, and most preferably 5% or less.

CaO is not essential, is a component that improves the meltability of the glass, and may be contained.

A content of CaO is preferably 0.5% or more, more preferably 1% or more, further preferably 2% or more, particularly preferably 3% or more, and most preferably 4% or more.

On the other hand, if the content of CaO is excessive, it is difficult to increase the compressive stress value during the chemical strengthening treatment. The content of CaO is 10% or less, preferably 9% or less, more preferably 8% or less, further preferably 7% or less, particularly preferably 6% or less, and most preferably 5% or less.

SrO is not essential, is a component that improves the meltability of the glass, and may be contained.

A content of SrO is preferably 0.5% or more, more preferably 1% or more, further preferably 2% or more, particularly preferably 3% or more, and most preferably 4% or more.

On the other hand, if the content of SrO is excessive, it is difficult to increase the compressive stress value during the chemical strengthening treatment. The content of SrO is 10% or less, preferably 9% or less, more preferably 8% or less, further preferably 7% or less, particularly preferably 6% or less, and most preferably 5% or less.

BaO is not essential, is a component that improves the meltability of the glass, and may be contained.

A content of BaO is preferably 0.5% or more, more preferably 1% or more, further preferably 2% or more, particularly preferably 3% or more, and most preferably 4% or more.

On the other hand, if the content of BaO is excessive, it is difficult to increase the compressive stress value during the chemical strengthening treatment. The content of BaO is 10% or less, preferably 9% or less, more preferably 8% or less, further preferably 7% or less, particularly preferably 6% or less, and most preferably 5% or less.

ZnO is not essential, is a component that improves the meltability of the glass, and may be contained.

A content of 7.nO is preferably 0.5% or more, more preferably 1% or more, further preferably 2% or more, particularly preferably 3% or more, and most preferably 4% or more.

On the other hand, if the content of ZnO is excessive, it is difficult to increase the compressive stress value during the chemical strengthening treatment. The content of ZnO is 10% or less, preferably 9% or less, more preferably 8% or less, further preferably 7% or less, particularly preferably 6% or less, and most preferably 5% or less.

ZrO₂ is not essential, is a component that enhances the mechanical strength and chemical durability, and is preferably contained in order to remarkably improve CS.

A content of ZrO₂ is preferably 0.2% or more, more preferably 0.5% or more, further preferably 1% or more, particularly preferably 2% or more, and most preferably 2.5% or more.

On the other hand, in order to prevent devitrification during melting, the content of ZrO₂ is preferably 5% or less, preferably 4.7% or less, more preferably 4.4% or less, further preferably 4% or less, particularly preferably 3.7% or less, and most preferably 3.5% or less.

TiO₂ is not essential, is a component that prevents solarization of the glass, is a component that can promote crystallization in a case of obtaining a crystallized glass, and may be contained. When TiO₂ is contained, a content of TiO₂ is preferably 0.1% or more, more preferably 0.5% or more, further preferably 1% or more, particularly preferably 1.5% or more, and most preferably 2% or more. On the other hand, in order to prevent devitrification during melting, the content of TiO₂ is preferably 5% or less, preferably 4.7% or less, more preferably 4.4% or less, further preferably 4% or less, particularly preferably 3.7% or less, and most preferably 3.5% or less.

SnO₂ is not essential, and may be contained because SnO₂ acts as a refining agent during glass manufacture and also acts to promote formation of crystal nuclei in the case of obtaining the crystallized glass. When SnO₂ is contained, a content of SnO₂ is preferably 0.02% or more, more preferably 0.05% or more, further preferably 0.08% or more, particularly preferably 0.1% or more, and most preferably 0.12% or more. On the other hand, in order to prevent devitrification during melting, the content of SnO₂ is preferably 5% or less, preferably 3% or less, more preferably 2% or less, further preferably 1% or less, particularly preferably 0.5% or less, and most preferably 0.3% or less.

La₂O₃, Nb₂O₅, and Ta₂O₅ are all components that prevent fragments from scattering when the chemically strengthened glass is broken, and may be contained in order to increase a refractive index. When these components are contained, a total content of La₂O₃, Nb₂O₅, and Ta₂O₅ (hereinafter, referred to as La₂O₃+Nb₂O₅+Ta₂O₅) is preferably 0.5% or more, more preferably 1% or more, further preferably 1.5% or more, and particularly preferably 2% or more. In order to prevent devitrification of the glass during melting, La₂O₃+Nb₂O₅+Ta₂O₅ is preferably 4% or less, more preferably 3% or less, further preferably 2% or less, and particularly preferably 1% or less.

CeO₂ may be contained. CeO₂ may prevent coloring by oxidizing the glass. When CeO₂ is contained, a content of CeO₂ is preferably 0.03% or more, more preferably 0.05% or more, and further preferably 0.07% or more. In order to increase the transparency, the content of CeO2 is preferably 1.5% or less, and more preferably 1.0% or less.

When the chemically strengthened glass is colored and used, a coloring component may be added within a range that does not impede achievement of desired chemical strengthening properties. Examples of the coloring component include Co₃O₄, MnO₂, Fe₂O₃, NiO, CuO, Cr₂O₃, V₂O₅, Bi₂O₃, SeO₂, Er₂O₃ and Nd₂O₃.

When Fe₂O₃ is contained, a content of Fe₂O₃ is 0.5% or less. A total content of the coloring component is preferably in a range of 1% or less. When it is desired to further increase a visible light transmittance of the glass, these components are preferably not substantially contained.

HfO₂, Nb₂O₅, and Ti₂O₃ may be added in order to increase a weather resistance against ultraviolet light irradiation. When HfO₂, Nb₂O₅, and Ti₂O₃ are added for the purpose of increasing the weather resistance against ultraviolet light irradiation, in order to reduce effects on other properties, a total content of HfO₂, Nb₂O₅, and Ti₂O₃ is preferably 1% or less, further preferably 0.5% or less, and more preferably 0.1% or less.

SO₃, a chloride, and a fluoride may be appropriately contained as a refining agent or the like during the melting of the glass. Since the strengthening properties and a crystallization behavior may be affected if too many components are added, a total content of components that function as the refining agent is, in terms of mass % based on oxides, preferably 2% or less, more preferably 1% or less, and further preferably 0.5% or less. Although a lower limit is not particularly limited, the total content is typically preferably 0.05% or more in terms of mass % based on oxides.

When SO₃ is used as the refining agent, since an effect cannot be achieved if a content

of SO₃ is too small, the content of SO₃ is, in terms of mass % based on oxides, preferably 0.01% or more, more preferably 0.05% or more, and further preferably 0.1% or more. When SO₃ is used as the refining agent, the content of SO₃ is, in terms of mass % based on oxides, preferably 1% or less, more preferably 0.8% or less, and further preferably 0.6% or less.

When Cl is used as the refining agent, since physical properties such as the strengthening properties may be affected if Cl is added too much, a content of Cl is, in terms of mass % based on oxides, preferably 1% or less, more preferably 0.8% or less, and further preferably 0.6% or less. When Cl is used as the refining agent, since an effect cannot be achieved if the content of Cl is too small, the content of Cl is, in terms of mass % based on oxides, preferably 0.05% or more, more preferably 0.1% or more, and further preferably 0.2% or more.

As₂O₃ is preferably not contained. When As₂O₃ is contained, a content of As₂O₃ is preferably 0.3% or less, more preferably 0.1% or less, and most preferably not contained.

The glass for chemical strengthening according to the first embodiment may be an amorphous glass or a crystallized glass.

### Second Embodiment

A base composition of the glass for chemical strengthening according to the second embodiment of the present invention preferably contains, in terms of mol % based on oxides, 40% to 70% of SiO₂, 10% to 35% of Li₂O, and 1% to 15% of Al₂O₃.

An aspect of the glass for chemical strengthening according to the second embodiment preferably contains, in terms of mol % based on oxides,
40% to 70% of SiO₂;
10% to 35% of Li₂O;
1% to 15% of Al₂O₃;
0.5% to 5% of P₂O₅;
0.5% to 5% of ZrO₂;
0% to 10% of B₂O₃;
0% to 3% of Na₂O;
0% to 1% of K₂O; and
0% to 4% of SnO₂. In the present specification, a crystallized glass having such compositions is also referred to as a “present crystallized glass x”.

Another aspect of the glass for chemical strengthening according to the second embodiment preferably contains, in terms of mol % based on oxides,
50% to 70% of SiO₂;
15% to 30% of Li₂O;
1% to 10% of Al₂O₃;
0.5% to 5% of P₂O₅;
0.5% to 8% of ZrO₂;
0.1% to 10% of MgO;
0% to 5% of Y₂O₃;
0% to 10% of B₂O₃;
0% to 3% of Na₂O;
0% to 1% of K₂O; and
0% to 2% of SnO₂. In the present specification, a crystallized glass having such compositions is also referred to as a “present crystallized glass y”.

In the present specification, the crystallized glass according to the present embodiment including the present crystallized glass x and the present crystallized glass y is also collectively referred to as the present crystallized glass. A total amount of SiO₂, Al₂O₃, P₂O₅, and B₂O₃ of the present crystallized glass is preferably 60% to 80% in terms of mol % based on oxides. SiO₂, Al₂O₃, P₂O₅, and B₂O₃ are glass network formers (hereinafter, also abbreviated as NWF). When the total amount of NWF is large, the strength of the glass is increased. Accordingly, in order to increase a fracture toughness value of the crystallized glass, the total amount of NWF is preferably 60% or more, more preferably 63% or more, and particularly preferably 65% or more. However, a glass containing too much NWF has a high melting temperature and is difficult to manufacture, and thus the total amount of NWF is preferably 85% or less, more preferably 80% or less, and more preferably 75% or less.

In the present crystallized glass, a ratio of a total amount of Li₂O, Na₂O, and K₂O to the total amount of NWF, that is, the total amount of SiO₂, Al₂O₃, P₂O₅, and B₂O₃ is preferably 0.20 to 0.60.

Li₂O, Na₂O, and K₂O are network modifiers, and lowering the ratio of the network modifiers to NWF increases a void in a network, and thus an impact resistance is improved. Therefore, a ratio of the total content of Li₂O, Na₂O), and K₂O to NWF is preferably 0.60 or less, more preferably 0.55 or less, and particularly preferably 0.50 or less. On the other hand, these components are necessary for chemical strengthening, and thus in order to improve the chemical strengthening properties, a ratio of the total content of Li₂O, Na₂O, and K₂O to NWF is preferably 0.20 or more, more preferably 0.25 or more, and particularly preferably 0.30 or more.

Hereinafter, the glass composition will be described.

In a present amorphous glass, SiO₂ is a component for forming a glass network structure. SiO₂ is a component for improving the chemical durability, and a content of SiO₂ is preferably 45% or more.

The content of SiO₂ is more preferably 48% or more, further preferably 50% or more, particularly preferably 52% or more, and extremely preferably 54% or more. On the other hand, in order to improve the meltability, the content of SiO₂ is preferably 70% or less, more preferably 68% or less, further preferably 66% or less, and particularly preferably 64% or less.

Al₂O₃ is a component that increases a surface compressive stress caused by chemical strengthening and is essential. A content of Al₂O₃ is preferably 1% or more, more preferably 2% or more, further preferably 3% or more, 5% or more, 5.5% or more, and 6% or more in this order, particularly preferably 6.5% or more, and most preferably 7% or more. On the other hand, in order to prevent the devitrification temperature of the glass from becoming excessively high, the content of Al₂O₃ is preferably 15% or less, more preferably 12% or less, further preferably 10% or less, particularly preferably 9% or less, and most preferably 8% or less.

Li₂O is a component that forms a surface compressive stress by ion exchange, and is a constituent component of the main crystal, and thus is essential. A content of Li₂O is preferably 10% or more, more preferably 14% or more, more preferably 15% or more, further preferably 18% or more, particularly preferably 20% or more, and most preferably 22% or more. On the other hand, in order to stabilize the glass, the content of Li₂O is preferably 35% or less, more preferably 32% or less, further preferably 30% or less, particularly preferably 28% or less, and most preferably 26% or less.

Na₂O is a component that improves the meltability of the glass. Na₂O is not essential, and when Na₂O is contained, a content of Na₂O is preferably 0.5% or more, more preferably 1% or more, and particularly preferably 2% or more. If Na₂O content is too large, crystals such as Li₃PO₄, which are main crystals, are less likely to be precipitated, or chemical strengthening properties are deteriorated, and thus, the content of Na₂O is preferably 10% or less, more preferably 9% or less, further preferably 8% or less, and particularly preferably 7% or less.

K₂O, like Na₂O), is a component that lowers the melting temperature of the glass and may be contained.

When K₂O is contained, a content of K₂O is preferably 0.5% or more, more preferably 1% or more, further preferably 1.5% or more, and particularly preferably 2% or more. If the content of K₂O is too large, the chemical strengthening properties are deteriorated, or the chemical durability is deteriorated, and thus the content of K₂O is preferably 5% or less, more preferably 4% or less, further preferably 3% or less, particularly preferably 2% or less, and most preferably 1% or less.

In order to improve the meltability of the glass raw material, a total content of Na₂O and K₂O, that is, Na₂O+K₂O is preferably 1% or more, and more preferably 2% or more.

A ratio of the content of K₂O to the total content of Li₂O, Na₂O, and K₂O (hereinafter, referred to as R₂O), that is, K₂O/R₂O is preferably 0.2 or less because the chemical strengthening properties can be enhanced, and the chemical durability can be enhanced. K₂O/R₂O is more preferably 0.15 or less, and further preferably 0.10 or less.

R₂O is preferably 10% or more, more preferably 15% or more, and further preferably 20% or more. R₂O is preferably 29% or less, and more preferably 26% or less.

P₂O₅ is a constituent component of Li₃PO₄ crystal and is essential. In order to promote crystallization, a content of P₂O₅ is preferably 0.5% or more, more preferably 1% or more, further preferably 1.5% or more, particularly preferably 2% or more, and extremely preferably 2.5% or more. On the other hand, if the content of P₂O₅ is too large, the phase separation is likely to occur during melting and the acid resistance is remarkably lowered, and thus the content of P₂O₅ is preferably 5% or less, more preferably 4.8% or less, further preferably 4.5% or less, and particularly preferably 4.2% or less.

ZrO₂ is a component that enhances the mechanical strength and chemical durability, and is preferably contained in order to remarkably improve CS. A content of ZrO₂ is preferably 0.5% or more, more preferably 1% or more, further preferably 1.5% or more, particularly preferably 2% or more, and most preferably 2.5% or more. On the other hand, in order to prevent the devitrification during melting, the content of ZrO₂ is preferably 8% or less, more preferably 7.5% or less, further preferably 7% or less, and particularly preferably 6% or less. If the content of ZrO₂ is too large, the devitrification temperature rises and then the viscosity decreases. In order to prevent deterioration of moldability due to such a decrease in the viscosity, if a molding viscosity is low, the content of ZrO₂ is preferably 5% or less, more preferably 4.5% or less, and further preferably 3.5% or less.

In order to enhance the chemical durability, ZrO₂/R₂O) is preferably 0.02 or more, more preferably 0.03 or more, further preferably 0.04 or more, particularly preferably 0.1 or more, and most preferably 0.15 or more. In order to increase transparency after crystallization, ZrO₂/R₂O is preferably 0.6 or less, more preferably 0.5 or less, further preferably 0.4 or less, and particularly preferably 0.3 or less.

MgO is a component that stabilizes the glass, and is also a component that enhances the mechanical strength and chemical resistance, and thus MgO is preferably contained if the content of Al₂O₃ is low. A content of MgO is preferably 1% or more, more preferably 2% or more, further preferably 3% or more, and particularly preferably 4% or more. On the other hand, if too much MgO is added, the viscosity of the glass is lowered, and the devitrification or the phase separation is likely to occur, and thus the content of MgO is preferably 10% or less, more preferably 9% or less, further preferably 8% or less, and particularly preferably 7% or less.

TiO₂ is a component capable of promoting the crystallization and may be contained. TiO₂ is not essential, and when TiO₂ is contained, a content of TiO₂ is preferably 0.2% or more, and more preferably 0.5% or more. On the other hand, in order to prevent the devitrification during melting, the content of TiO₂ is preferably 4% or less, more preferably 2% or less, and further preferably 1% or less.

SnO₂ has an effect of promoting formation of a crystal nucleus and may be contained. SnO₂ is not essential, and when SnO₂ is contained, a content of SnO₂ is preferably 0.5% or more, more preferably 1% or more, further preferably 1.5% or more, and particularly preferably 2% or more. On the other hand, in order to prevent devitrification during melting, the content of SnO₂ is preferably 6% or less, more preferably 5% or less, further preferably 4% or less, and particularly preferably 3% or less.

Y₂O₃ is a component that has an effect of preventing fragments from scattering when the chemically strengthened glass is broken, and may be contained. A content of Y₂O₃ is preferably 1% or more, more preferably 1.5% or more, further preferably 2% or more, particularly preferably 2.5% or more, and extremely preferably 3% or more. On the other hand, in order to prevent the devitrification during melting, the content of Y₂O₃ is preferably 5% or less, and more preferably 4% or less.

B₂O₃ is a component that improves the chipping resistance of the glass for chemical strengthening or the chemically strengthened glass and improves the meltability, and may be contained. When B₂O₃ is contained, in order to improve the meltability, a content of B₂O₃ is preferably 0.5% or more, more preferably 1% or more, and further preferably 2% or more. On the other hand, if the content of B₂O₃ is too large, striae may occur during melting, or phase separation is likely to occur, and then a quality of the glass for chemical strengthening is likely to deteriorate, and thus the content of B₂O₃ is preferably 5% or less. The content of B₂O₃ is more preferably 4% or less, further preferably 3% or less, and particularly preferably 2% or less.

BaO, SrO, MgO, CaO, and ZnO are components that improve the meltability of the glass, and may be contained. When these components are contained, a total content of BaO, SrO, MgO, CaO, and ZnO (hereinafter referred to as BaO+SrO+MgO+CaO+ZnO) is preferably 0.5% or more, more preferably 1% or more, further preferably 1.5% or more, and particularly preferably 2% or more. On the other hand, since an ion exchange rate decreases, BaO+SrO+MgO+CaO+ZnO is preferably 8% or less, more preferably 6% or less, further preferably 5% or less, and particularly preferably 4% or less.

BaO, SrO, and ZnO may be contained in order to improve a refractive index of a residual glass to be close to a precipitated crystal phase, thereby improving a light transmittance of the crystallized glass to decrease a haze value. In this case, a total content of BaO, SrO, and ZnO (hereinafter, referred to as BaO+SrO+ZnO) is preferably 0.3% or more, more preferably 0.5% or more, further preferably 0.7% or more, and particularly preferably 1% or more. On the other hand, these components may reduce the ion exchange rate. In order to improve the chemical strengthening properties, BaO+SrO+ZnO is preferably 2.5% or less, more preferably 2% or less, further preferably 1.7% or less, and particularly preferably 1.5% or less.

La₂O₃, Nb₂O₅, and Ta₂O₅ are all components that prevent fragments from scattering when the chemically strengthened glass is broken, and may be contained in order to increase a refractive index. When these components are contained, a total content of La₂O₃, Nb₂O₅, and Ta₂O₅ (hereinafter, referred to as La₂O₃+Nb₂O₅+Ta₂O₅) is preferably 0.5% or more, more preferably 1% or more, further preferably 1.5% or more, and particularly preferably 2% or more. In order to prevent devitrification of the glass during melting, La₂O₃+Nb₂O₅+Ta₂O₅ is preferably 4% or less, more preferably 3% or less, further preferably 2% or less, and particularly preferably 1% or less.

CeO₂ may be contained. CeO₂ may prevent coloring by oxidizing the glass. When CeO₂ is contained, a content of CeO₂ is preferably 0.03% or more, more preferably 0.05% or more, and further preferably 0.07% or more. In order to increase the transparency, the content of CeO₂ is preferably 1.5% or less, and more preferably 1.0% or less.

When the strengthened glass is colored and used, a coloring component may be added within a range that does not impede achievement of desired chemical strengthening properties. Examples of the coloring component include Co₃O₄, MnO₂, Fe₂O₃, NiO, CuO, Cr₂O₃, V₂O₅, Bi₂O₃, SeO₂, Er₂O₃ and Nd₂O₃.

A total content of the coloring component is preferably in a range of 1% or less. When it is desired to further increase a visible light transmittance of the glass, these components are preferably not substantially contained.

SO₃, a chloride, and a fluoride may be appropriately contained as a refining agent or the like during the melting of the glass. As₂O₃ is preferably not contained. When As₂O₃ is contained, a content of As₂O₃ is preferably 0.3% or less, more preferably 0.1% or less, and most preferably not contained.

The glass for chemical strengthening according to the second embodiment is preferably a crystallized glass.

Here, when each of the glasses for chemical strengthening according to the first embodiment and the second embodiment is a crystallized glass, it is preferable that a composition obtained by combining components of a crystal phase and a glass phase of the crystallized glasses is within the above-described range. The composition of the crystallized glass is obtained by subjecting the crystallized glass to the heat treatment at a temperature equal to or higher than a melting point to analyze the crystallized glass. An example of a method for analyzing the glass composition is fluorescent X-ray analysis.

When each of the glasses for chemical strengthening according to the first embodiment and the second embodiment is a crystallized glass, crystal species are not particularly limited, and it is preferable to contain one or more crystals selected from the group consisting of, for example, a lithium silicate crystal, a lithium aluminosilicate crystal, and a lithium phosphate crystal. The lithium silicate crystal is preferably a lithium metasilicate crystal, a lithium disilicate crystal, or the like.

The lithium phosphate crystal is preferably a lithium orthophosphate crystal or the like. The lithium aluminosilicate crystal is preferably a β-spodumene crystal, a petalite crystal, or the like.

When each of the glasses for chemical strengthening according to the first embodiment and the second embodiment is a crystallized glass, a crystallization rate of the crystallized glass is not particularly limited, but in order to enhance the mechanical strength, the crystallization rate is preferably 10% or more, more preferably 15% or more, further preferably 20% or more, and particularly preferably 25% or more. In order to increase the transparency, the crystallization rate of the crystallized glass is preferably 70% or less, more preferably 60% or less, and particularly preferably 50% or less. The low crystallization rate is also excellent in that the glass is easily bent by heating. The crystallization rate can be calculated from the X-ray diffraction intensity by the Rietveld method. The Rietveld method is described in “Crystal Analysis Handbook” edited by the Crystallographic Society of Japan and “Crystal Analysis Handbook” editing committee (Kyoritsu Shuppan, 1999, p492 to 499).

The chemically strengthened glass according to the present embodiment includes chemically strengthened glasses according to a third embodiment to a sixth embodiment described below.

### Third Embodiment

In the chemically strengthened glass according to the third embodiment of the present invention, K-DOL defined below is 4.2 μm or more and a surface resistivity is 11 [log Ω/sq] or more.

K-DOL (μm): value of depth from glass surface of compressive stress layer caused by potassium ion

As described above, it is considered that the chemically strengthened glass in which a compressive stress layer caused by the potassium ion having a relatively large size is formed tends to have a high resistance. Here, a relatively large K-DOL means that the depth of the compressive stress layer caused by the potassium ions is relatively large.

That is, according to the chemically strengthened glass according to the third embodiment, a high-resistance compressive stress layer caused by the potassium ion is formed deeply, so that the chemically strengthened glass having a large surface resistivity can be obtained.

In the chemically strengthened glass according to the third embodiment, K-DOL is 4.2 μm or more, preferably 5.0 μm or more, more preferably 6 μm or more, further preferably 8.0 μm or more, particularly preferably 10.0 μm or more, and most preferably 12.0 μm or more. On the other hand, from a viewpoint of maintaining a high deep stress caused by the Na ion, the K-DOL is preferably 30 μm or less, more preferably 25 μm or less, further preferably 20 μm or less, particularly preferably 18 μm or less, and most preferably 15 μm or less.

In the chemically strengthened glass according to the third embodiment, the surface resistivity is 11 [log Ω/sq] or more, preferably 11.5 [log Ω/sq] or more, and more preferably 12 [log Ω/sq] or more.

### Fourth Embodiment

In the chemically strengthened glass according to the fourth embodiment of the present invention, K-CSarea defined below is 4000 Pam or more and a surface resistivity is 11 [log Ω/sq] or more.

K-CSarea (Pa·m): product of K-CS₀ and K-DOL

K-CS₀ (MPa): compressive stress value on glass surface measured by film stress measurement

K-DOL (μm): value of depth from glass surface of compressive stress layer caused by potassium ion

As described above, it is considered that the chemically strengthened glass in which a compressive stress layer caused by the potassium ion having a relatively large size is formed tends to have a high resistance. Here, a relatively large K-CSarea means that a total amount of compressive stress caused by the potassium ions is large. That is, according to the chemically strengthened glass according to the fourth embodiment, the total amount of the compressive stress caused by the potassium ions is large, so that the chemically strengthened glass having a large surface resistivity can be obtained.

In the chemically strengthened glass according to the fourth embodiment, K-CSarea is 4000 Pa·m or more, preferably 4100 Pa·m or more, 4700 Pa·m or more, 5000 Pa·m or more in order, more preferably 6000 Pa·m or more, most preferably 10000 Pa·m or more. On the other hand, from the viewpoint of maintaining the high deep stress caused by the Na ion, the K-CSarea is preferably 50000 Pa·m or less, more preferably 40000 Pa·m or less, further preferably 30000 Pa·m or less, particularly preferably 20000 Pa·m or less, and most preferably 18000 Pa·m or less.

In the chemically strengthened glass according to the fourth embodiment, the surface resistivity is 11 [log Ω/sq] or more, preferably 11.5 [log Ω/sq] or more, and more preferably 12 [log Ω/sq] or more.

### Fifth Embodiment

In the chemically strengthened glass according to the fifth embodiment of the present invention, a ratio of K₂O@3 μm, which is a concentration of K₂O at a depth of 3 μm from the glass surface, to K₂O@center, which is a concentration of K₂O at the sheet thickness central portion, is 5.3 or more, and the surface resistivity is 11 [log Ω/sq] or more.

That the ratio of K₂O@3 μm to K₂O@center is 5.3 or more means that the total amount of potassium ions is relatively large in a range up to the depth of 3 μm. That is, according to the chemically strengthened glass according to the fifth embodiment, a high-resistance compressive stress layer caused by the potassium ion is sufficiently formed, and the chemically strengthened glass having a large surface resistivity can be obtained.

In the chemically strengthened glass according to the fifth embodiment, a ratio of K₂O@3 μm to K₂O@center is 5.3 or more, preferably 5.5 or more, more preferably 6.0 or more, further preferably 6.5 or more.

On the other hand, from the viewpoint of maintaining the high deep stress caused by the Na ion, the value of the ratio is preferably 20 or less, more preferably 18 or less, further preferably 15 or less, particularly preferably 12 or less, and most preferably 11 or less.

In the chemically strengthened glass according to the fifth embodiment, the surface resistivity is 11 [log Ω/sq] or more, preferably 11.5 [log Ω/sq] or more, and more preferably 12 [log Ω/sq] or more. An upper limit of the surface resistivity is not particularly limited.

### Sixth Embodiment

In the chemically strengthened glass according to the sixth embodiment of the present invention, a ratio of a concentration of Li₂O at a depth of 5 μm from the glass surface to a concentration of Li₂O at the sheet thickness central portion is 0.85 or less, and the surface resistivity is 11 [log Ω/sq] or more.

That the ratio of Li₂O@5 μm, which is the concentration of Li₂O at the depth of 5 μm from the glass surface, to Li₂O@center, which is the concentration of Li₂O at the sheet thickness central portion, is 0.85 or less means that a total amount of lithium ions is relatively small in a range up to the depth of 5 μm. The lithium ions are relatively small in the alkali metal ions. Therefore, when the lithium ions exist on the surface layer of the chemically strengthened glass, it is considered that if another alkali metal ion exists in the surroundings, there is a possibility of increasing the resistance due to a mixed alkali effect, but it is difficult to obtain an effect due to the size of the substituted alkali metal ion, and the resistance may be lowered. Regarding this, according to the chemically strengthened glass according to the sixth embodiment, an amount of lithium ions contained in the surface layer is small, and the effect due to the size of the substituted alkali metal ions can be sufficiently obtained. Accordingly, the chemically strengthened glass having a high-resistance compressive stress layer and a large surface resistivity is obtained.

In the chemically strengthened glass according to the sixth embodiment, the ratio of Li₂O@5 μm to Li₂O@center is 0.85 or less, preferably 0.84 or less, more preferably 0.82 or less, further preferably 0.80 or less, and most preferably 0.77 or less. On the other hand, from a viewpoint of improving the properties of introducing the Na ion deeply into the glass by ion exchange, the value of the ratio is preferably 0 or more, more preferably 0.1 or more, further preferably 0.2 or more, particularly preferably 0.3 or more, and most preferably 0.4 or more.

In the chemically strengthened glass according to the sixth embodiment, the surface resistivity is 11 [log Ω/sq] or more, preferably 11.5 [log Ω/sq] or more, and more preferably 12 [log Ω/sq] or more. An upper limit of the surface resistivity is not particularly limited.

In the chemically strengthened glass according to the present embodiment, a value of Y defined below is preferably 9.4 or more.

$$Y = 0.000208 {x}_{1} + 4.3 \times 1 {0}^{- 7} {x}_{2} + 8.8$$

x₁: product K-CSarea (Pa·m) of K-CS₀ and K-DOL
x₂: product Na-CSarea (Pa·m) of Na-CS₀ and Na-DOL
K-CS₀ (MPa): compressive stress value on glass surface measured by film stress measurement
K-DOL (μm): value of depth from glass surface of compressive stress layer caused by potassium ion
Na-CS₀ (MPa): compressive stress value on glass surface measured by scattered light photoelastic stress meter
Na-DOL (μm): value of depth from glass surface of compressive stress layer caused by Na ion

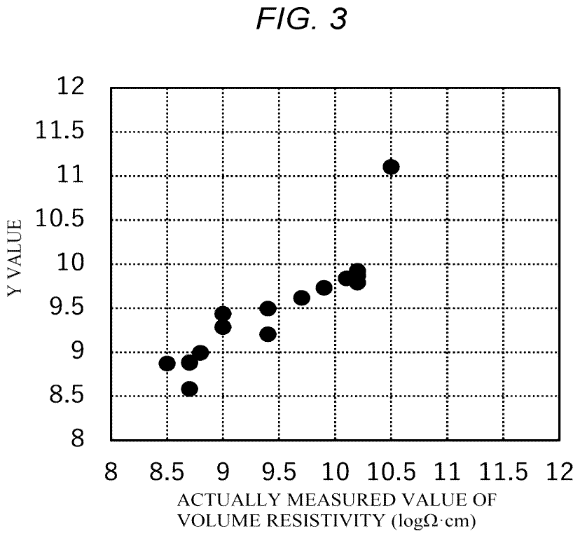

FIG. 3 is a diagram showing a relationship between the value of Y and an actually measured value of the volume resistivity of the chemically strengthened glass in the embodiment of the present invention. The inventors find that as shown in FIG. 3, the value of Y correlates well with the volume resistivity of the chemically strengthened glass, and the larger the value of Y, the larger the volume resistivity of the chemically strengthened glass. That is, in the present embodiment, the value of Y is relatively large, so that a chemically strengthened glass having a large volume resistivity can be obtained. It can be seen that in order to increase the value of Y, increasing K-CSarea (x₁) and increasing Na-CSarea (x₂) are both effective, and in particular, increasing x₁ is more effective.

The value of Y is preferably 9.4 or more, preferably 9.6 or more, more preferably 9.8 or more, further more preferably 10 or more, still further more preferably 10.3 or more, particularly preferably 10.6 or more, and most preferably 10.9 or more. An upper limit of the value of Y is not particularly limited.

x₁ represents a product of K-CS₀ and K-DOL, that is, K-CSarea (Pa·m). K-CSarea is preferably 4000 Pa·m or more, more preferably 4100 Pa·m or more, 4700 Pa·m or more, 5000 Pa·m or more in order, further more preferably 6000 Pa·m or more, and particularly preferably 10000 Pa·m or more. On the other hand, from the viewpoint of maintaining the high deep stress caused by the Na ion, the K-CSarea is preferably 50000 Pa·m or less, more preferably 40000 Pa·m or less, further preferably 30000 Pa·m or less, particularly preferably 20000 Pa·m or less, and most preferably 18000 Pa·m or less.

x₂ represents a product of Na-CS₀ and Na-DOL, that is, Na-CSarea (Pa19 m). From a viewpoint of enhancing a drop strength, when the thickness of the glass is t (mm), Na-CSarea is preferably (10000×t+1000) Pa·m or more, more preferably (10000×t+6000) Pa·m or more, further preferably (10000×t+16000) Pa·m or more, particularly preferably (10000×t+26000) Pa·m or more, and most preferably (10000×t+31000) Pa·m or more. On the other hand, from a viewpoint of limiting a stress of the glass to the tensile stress equal to or less than a CT limit, Na-CSarea is preferably (140000×t+2000) Pa·m or less, more preferably (140000×t−8000) Pa·m or less, further preferably (140000×t−18000) Pa·m or less, particularly preferably (140000×t−28000) Pa·m or less, and most preferably (140000×t−30000) Pa·m or less.

When the compressive stress layer is formed at a surface portion of a glass article, the tensile stress (hereinafter, also abbreviated as “CT”) corresponding to a total amount of the compressive stress on the surface is inevitably generated in the center of the glass article. If a tensile stress value becomes too large, when the glass article is cracked, the glass article breaks violently and broken pieces are scattered. When CT exceeds a threshold (hereinafter, also abbreviated as CT limit), the number of broken pieces at the time of damage increases explosively.

Therefore, while the chemically strengthened glass increases the compressive stress on the surface and forms the compressive stress layer in a deeper portion, the total amount of the compressive stress on the surface layer is designed so as not to exceed the CT limit (for example, U.S. Pat. No. 9,487,434B2, US2017/355640A1, U.S. Pat. No. 9,593,042B2, or JP2019-513663A).

### Chemically Strengthened Glass

More preferable aspects of the chemically strengthened glass according to each of the above-described embodiments include the following.

From a viewpoint of enhancing a bending strength, K-CS₀ (MPa) is preferably 800 MPa or more, more preferably 850 MPa or more, further preferably 900 MPa or more, particularly preferably 950 MPa or more, and most preferably 1000 MPa or more.

From the viewpoint of enhancing the drop strength, when the thickness of the glass is t (mm), Na-DOL (μm) is preferably (50×t+15) μm or more, more preferably (50×t+25) um or more, further preferably (50×t+45) μm or more, particularly preferably (50×t+65) um or more, and most preferably (50×t+85) μm or more. On the other hand, from the viewpoint of limiting the stress of the glass to the tensile stress equal to or less than the CT limit, Na-DOL is preferably (100×t+95) μm or less, more preferably (100×t+90) μm or less, further preferably (100×t+88) μm or less, particularly preferably (100×t+86) μm or less, and most preferably (100×t+84) μm or less.

From the viewpoint of enhancing the drop strength, Na-CSo (MPa) is preferably 150 MPa or more, more preferably 200 MPa or more, further preferably 250 MPa or more, particularly preferably 280 MPa or more, and most preferably 300 MPa or more. On the other hand, from the viewpoint of limiting the stress of the glass to the tensile stress equal to or less than the CT limit, Na-CSo is preferably 650 MPa or less, more preferably 600 MPa or less, further preferably 580 MPa or less, particularly preferably 550 MPa or less, and most preferably 520 MPa or less.

From the viewpoint of enhancing the bending strength, CS₁ (MPa) which is a compressive stress value at a depth of 1 μm from the glass surface is preferably 700 MPa or more, more preferably 750 MPa or more, further preferably 800 MPa or more, particularly preferably 850 MPa or more, and most preferably 900 MPa or more.

From the viewpoint of enhancing the bending strength, CS₂ (MPa) which is a compressive stress value at a depth of 2 μm from the glass surface is preferably 550 MPa or more, more preferably 600 MPa or more, further preferably 650 MPa or more, particularly preferably 700 MPa or more, and most preferably 750 MPa or more.

From the viewpoint of enhancing the drop strength, when the thickness of the glass is t (mm), CS₅₀ (MPa) which is a compressive stress value at a depth of 50 μm from the glass surface is preferably (140×t) MPa or more, more preferably (140×t+20) MPa or more, further preferably (140×t+30) MPa or more, particularly preferably (140×t+40) MPa or more, and most preferably (140×t+50) MPa or more.

From the viewpoint of enhancing the drop strength, when the thickness of the glass is t (mm), CS₉₀ (MPa) which is a compressive stress value at a depth of 90 μm from the glass surface is preferably (40×t) MPa or more, more preferably (40×t+5) MPa or more, further preferably (40×t+10) MPa or more, particularly preferably (40×t+20) MPa or more, and most preferably (40×t+30) MPa or more.

CTave (MPa) corresponds to an average value of the tensile stress obtained by the above-described method. From the viewpoint of enhancing the drop strength, when the thickness of the glass ist (mm), CTave is preferably (−50×t+88) MPa or more, more preferably (−50×t+90) MPa or more, further preferably (−50×t+91) MPa or more, and most preferably (−50×t+92) MPa or more. On the other hand, from the viewpoint of limiting the stress of the glass to the tensile stress equal to or less than the CT limit, CTave is preferably less than a value of CTA obtained by Equation (1).

$$\begin{matrix}[ Formula 1 ] & \\ CTA = 317.93 \times K 1 c / \sqrt{t} + 228.5 \times t - 398 & Equation ( 1 )\end{matrix}$$

t: sheet thickness [mm]
K1c: fracture toughness value (MPa·m^{1/2})
A value obtained by subtracting the value of CTave from CTA is preferably 1 MPa or more, more preferably 2 MPa or more, and most preferably 3 MPa or more.

ICT (Pa·m) represents an integrated value of the tensile stress. From the viewpoint of enhancing the drop strength, when the sheet thickness of the glass is t (mm), ICT is preferably (32235×t+1000) Pa·m or more, more preferably (32235×t+2000) Pa·m or more, further preferably (32235×t+3000) Pa·m or more, particularly preferably (32235×t+4000) Pa·m or more, and most preferably (32235×t+5000) Pa·m or more. On the other hand, from the viewpoint of limiting the stress of the glass to the tensile stress equal to or less than the CT limit, ICT is preferably (32235×t+27000) Pa·m or less, more preferably (32235×t+25000) Pa·m or less, further preferably (32235×t+23000) Pa·m or less, particularly preferably (32235×t+20000) Pa·m or less, and most preferably (32235×t+15000) Pa·m or less.

### Glass for Chemical Strengthening and Chemically Strengthened Glass

The glass for chemical strengthening and the chemically strengthened glass according to each of the above-described embodiments will be described.

A shape of the glass for chemical strengthening or the chemically strengthened glass is not particularly limited, and is typically sheet-shaped, and may be flat or curved. The glass may have portions having different thicknesses.

When the glass for chemical strengthening or the chemically strengthened glass is sheet-shaped, the thickness (t) thereof is preferably 3000 μm or less, more preferably 2000 μm or less, 1600 μm or less, 1500 μm or less, 1100 μm or less, 900 μm or less, 800 μm or less, 700 μm or less in a stepwise manner. In order to obtain a sufficient strength by the chemical strengthening treatment, the thickness (t) is preferably 300 μm or more, more preferably 400 um or more, and further preferably 500 μm or more.

The glass for chemical strengthening according to the embodiment of the present invention is easy to obtain a chemically strengthened glass having a high electrical resistance by the chemical strengthening treatment, and is suitable for obtaining a chemically strengthened glass that can prevent the abnormal emission phenomenon. Since the chemically strengthened glass according to the embodiment of the present invention has a high electrical resistance and can prevent the abnormal emission phenomenon, the chemically strengthened glass of the present invention is particularly useful as a cover glass for use in an electronic device such as a mobile device such as a mobile phone and a smartphone. Furthermore, the chemically strengthened glass of the present invention is also useful for a cover glass of an electronic device such as a television, a personal computer, and a touch panel, an elevator wall surface, or a wall surface (full-screen display) of a construction such as a house and a building, which is not intended to be carried. The chemically strengthened glass of the present invention is also useful as a building material such as a window glass, a table top, an interior of an automobile, an airplane, or the like, and a cover glass thereof, or useful for a casing having a curved surface shape. That is, the present invention relates to an electronic device provided with the glass for chemical strengthening according to the embodiment of the present invention or the chemically strengthened glass according to the embodiment of the present invention.

### Methods for Manufacturing Glass for Chemical Strengthening and Chemically Strengthened Glass

Methods for manufacturing the glass for chemical strengthening and the chemically strengthened glass according to the present embodiment will be described.

For example, when manufacturing a sheet-shaped glass for chemical strengthening, glass raw materials are appropriately prepared and heated and melted in a glass melting furnace so that a glass having the above-described composition can be obtained. Thereafter, the glass is homogenized by bubbling, stirring, addition of a refining agent, and the like, formed into a glass sheet having a predetermined thickness, and slowly cooled to obtain a glass for chemical strengthening. Alternatively, the glass for chemical strengthening may be obtained by forming the glass into a block shape, slowly cooling the glass, and then cutting the glass to form the glass into a sheet shape. When the glass for chemical strengthening is a crystallized glass, a heat treatment step for crystallization or the like may be included.

Examples of the method for forming into a sheet shape include a float method, a press method, a fusion method, and a down draw method. The float method is particularly preferable when manufacturing a large glass sheet. As a continuous forming method other than the float method, for example, a fusion method and a down-draw method are also preferable.

The chemically strengthened glass can be obtained by performing an ion exchange treatment on the glass for chemical strengthening. For example, as the method for manufacturing the above-described glasses according to the third embodiment to the sixth embodiment, it is preferable to manufacture the chemically strengthened glass using the glass for chemical strengthening according to the first embodiment or the second embodiment, or to manufacture the chemically strengthened glass by chemical strengthening using a preferred chemical strengthening process described below, and it is more preferable to manufacture the chemically strengthened glass by using the composition of the glass according to the first embodiment or the second embodiment as the base composition, and performing chemical strengthening by a preferable chemical strengthening process described below.

In the present embodiment, it is preferable to perform a two-stage ion exchange treatment. However, the above matter does not in any way prevent the chemically strengthened glass according to each of the above-described embodiments from being obtained by performing a one-stage ion exchange treatment or an ion exchange treatment with three or more stages.

When the two-stage ion exchange treatment is performed, a first alkali metal ion in the glass for chemical strengthening is exchanged with a second alkali metal ion in a first molten salt composition by a first ion exchange treatment. The second alkali metal ion in the glass for chemical strengthening is exchanged with a third alkali metal ion in a second molten salt composition by a second ion exchange treatment.

In the present description, the term “molten salt composition” refers to a composition containing a molten salt. Examples of the molten salt contained in the molten salt composition include a nitrate, a sulfate, a carbonate, and a chloride. Examples of nitrate include lithium nitrate, sodium nitrate, potassium nitrate, cesium nitrate, rubidium nitrate, and silver nitrate. Examples of sulfate include lithium sulfate, sodium sulfate, potassium sulfate, cesium sulfate, rubidium sulfate, and silver sulfate. Examples of chloride include lithium chloride, sodium chloride, potassium chloride, cesium chloride, rubidium chloride, and silver chloride. These molten salts may be used alone or in combination of plurality kinds thereof.

The molten salt composition is preferably a composition containing a nitrate as a base component, and more preferably a composition containing sodium nitrate or potassium nitrate as a main component. Here, the term “as a main component” means that a content in the molten salt composition is 80 mass % or more.

The method for manufacturing the chemically strengthened glass according to the present embodiment relates to, for example, a method for manufacturing a chemically strengthened glass including the first ion exchange treatment of bringing the glass for chemical strengthening into contact with the first molten salt composition, and the second ion exchange treatment of bringing the glass for chemical strengthening into contact with the second molten salt composition after the first ion exchange treatment. The second molten salt composition contains 94 mass % or more of potassium nitrate (KNO₃) and less than 100 mass ppm of lithium ions.

In the above-described method for manufacturing, it is preferable that a temperature of the second molten salt composition in the second ion exchange treatment is 380° C. to 450° C., and that a time for bringing the second molten salt composition into contact with the glass for chemical strengthening is 60 minutes or more.

In the above-described method for manufacturing, the second molten salt composition preferably contains 0 mass % to 5 mass % of sodium nitrate (NaNO₃).

The method for manufacturing the chemically strengthened glass according to the present embodiment may relate to, for example, a method for manufacturing a chemically strengthened glass including performing an ion exchange treatment on a glass for chemical strengthening to obtain the chemically strengthened glass, and obtaining the chemically strengthened glass having a K-DOL of 4.2 μm or more and a surface resistivity of 11 [log Ω/sq] or more.

The method for manufacturing the chemically strengthened glass according to the present embodiment may relate to, for example, a method for manufacturing a chemically strengthened glass including performing an ion exchange treatment on a glass for chemical strengthening to obtain the chemically strengthened glass, and obtaining the chemically strengthened glass having a K-CSarea of 4000 Pa·m or more and a surface resistivity of 11 [logQ/sq] or more.

Hereinafter, the first ion exchange treatment and the second ion exchange treatment will be described in detail.

### <<First Ion Exchange Treatment>>

In one embodiment, in the first ion exchange treatment, it is preferable to bring the glass for chemical strengthening including the first alkali metal ion into contact with the first molten salt composition including the second alkali metal ion having a larger ionic radius than that of the first alkali metal ion to exchange the ion. In the present embodiment, the second alkali metal ion is introduced into the glass for chemical strengthening by the first ion exchange treatment.

The component of the first molten salt composition used in the first ion exchange treatment is not particularly limited as long as the component does not impair the effects of the present invention, and as one embodiment, the second alkali metal ion having a larger ionic radius than that of the first alkali metal ion contained in the glass for chemical strengthening is preferably contained. It is preferable that the first molten salt composition further contains the third alkali metal ion having a larger ionic radius than that of the second alkali metal ion.

In one embodiment, when the first alkali metal ion is a lithium ion, the second alkali metal ion is preferably a sodium ion, and the third alkali metal ion is preferably a potassium ion.

Examples of the molten salt used for the first molten salt composition and containing a sodium ion include sodium nitrate, sodium sulfate, and sodium chloride, and sodium nitrate is preferred.

As one embodiment, when the first molten salt composition contains sodium nitrate, a content of sodium nitrate is preferably 20 mass % or more and 100 mass % or less. Here, a lower limit of the content is more preferably 25 mass % or more, and further preferably 30 mass % or more. An upper limit of the content is more preferably 80 mass % or less, and further preferably 60 mass % or less.

Examples of the molten salt used for the first molten salt composition and containing a potassium ion include potassium nitrate, potassium sulfate, and potassium chloride, and potassium nitrate is preferred.

As one embodiment, when the first molten salt composition contains potassium nitrate, a content of potassium nitrate is preferably 20 mass % or more and 80 mass % or less. Here, a lower limit of the content is more preferably 30 mass % or more, further preferably 40 mass % or more, and most preferably 50 mass % or more. An upper limit of the content is more preferably 70 mass % or less, and further preferably 60 mass % or less.

In the first ion exchange treatment, the glass for chemical strengthening is preferably brought into contact with the first molten salt composition at 380° C. or higher. When the temperature of the first molten salt composition is 380° C. or higher, the ion exchange easily progresses. The temperature of the first molten salt composition is more preferably 400° C. or higher, further preferably 410° C. or higher, and particularly preferably 420° C. or higher. The temperature of the first molten salt composition is usually 450° C. or lower from viewpoints of danger due to evaporation and changes in the composition of the molten salt composition.

In the first ion exchange treatment, a time for the glass for chemical strengthening to come into contact with the first molten salt composition is preferably 0.5 hours or longer because the surface compressive stress increases. The contact time is more preferably 1 hour or longer. When the contact time is too long, not only does productivity decrease, but the compressive stress may decrease due to a relaxation phenomenon. Therefore, the contact time is usually 8 hours or less.

The first ion exchange treatment may be a one-stage treatment, or a treatment (multi-stage strengthening) with two or more stages under two or more different conditions.

### <<Second Ion Exchange Treatment>>

The second ion exchange treatment is a step, after the first ion exchange treatment, of bringing the glass for chemical strengthening into contact with the second molten salt composition having a component ratio different from that of the first molten salt composition to exchange the ion.

In the second ion exchange treatment of the present method for manufacturing the glass, the second molten salt composition preferably contains the third alkali metal ion having a larger ionic radius than that of the second alkali metal ion. In the second molten salt composition, the content of the first alkali metal ion is preferably relatively small. In one embodiment, when the second alkali metal ion is a sodium ion, the third alkali metal ion is preferably a potassium ion, and the first alkali metal ion is preferably a lithium ion.

Examples of the molten salt used for the second molten salt composition and containing a potassium ion include potassium nitrate, potassium sulfate, and potassium chloride, and potassium nitrate is preferred.

As one embodiment, when the second molten salt composition contains potassium nitrate (KNO₃), a content of potassium nitrate is preferably 94 mass % or less. Here, a lower limit of the content is more preferably 96 mass % or more, and further preferably 98 mass % or more. An upper limit of the content may be 100 mass % or less, and is preferably 99.5 mass % or less, and more preferably 99 mass % or less. When the second molten salt composition contains potassium nitrate, the content of potassium nitrate is large, so that an effect of increasing resistance due to the size of the substituted alkali metal ion in the chemically strengthened glass is easily obtained, and it is suitable for obtaining the chemically strengthened glass according to the present embodiment.

The second molten salt composition may contain at least one of the lithium ion and the sodium ion. Examples of the molten salt used for the second molten salt composition and containing the lithium ion include lithium nitrate, lithium sulfate, and lithium chloride, and lithium nitrate is preferred. Examples of the composition used for the second molten salt composition and containing the sodium ion include sodium nitrate, sodium sulfate, and sodium chloride, and sodium nitrate is preferred.

In the second molten salt composition, the content of the lithium ion is preferably less than 300 mass ppm, more preferably 200 mass ppm or less, 100 mass ppm or less, 80 mass ppm or less in this order, and further preferably 60 mass ppm or less. Accordingly, it is possible to prevent the lithium ion from penetrating the surface layer of the chemically strengthened glass, which may cause the resistance to become low. The content of the lithium ion may be 0 mass ppm, but from a viewpoint of mass productivity of the chemically strengthened glass, the content of the lithium ion may be 40 mass ppm or more. When the second molten salt composition contains lithium nitrate (LiNO₃), it is preferable that the content of the lithium ion in the second molten salt composition falls within the above-described preferred range.

When the second molten salt composition contains sodium nitrate (NaNO₃), a content of sodium nitrate is preferably 0.5 mass % or more, more preferably 1 mass % or more, and further preferably 1.5 mass % or more. From a viewpoint of maintaining high surface layer stress, the content of sodium nitrate is preferably 5 mass % or less, more preferably 4 mass % or less, and further preferably 3 mass % or less.

In the second ion exchange treatment, the glass for chemical strengthening is preferably brought into contact with the second molten salt composition at 450° C. or lower. When the temperature of the second molten salt composition is 450° C. or lower, a change in the molten salt composition can be prevented. The temperature of the second molten salt composition is more preferably 440° C. or lower, further preferably 430° C. or lower, and particularly preferably 420° C. or lower. From a viewpoint of accelerating the ion exchange, the temperature of the second molten salt composition is preferably 380° C. or higher, more preferably 390° C. or higher, and further preferably 400° C. or higher.

In the second ion exchange treatment, from a viewpoint of stably performing the ion exchange, a time (treatment time) for the glass for chemical strengthening to come into contact with the second molten salt composition is preferably 60 minutes or more, more preferably 90 minutes or more, and further preferably 120 minutes or more. On the other hand, from a viewpoint that productivity decreases if the contact time is too long, the contact time in the second ion exchange treatment is preferably 300 minutes or less, more preferably 240 minutes or less, and further preferably 180 minutes or less.

### EXAMPLES

Although the present invention will be described below using Examples, the present invention is not limited to those Examples.

### <Preparation of Amorphous Glass and Crystallized Glass>

Glass raw materials were prepared so as to contain compositions shown below in terms of mole percentage based on oxides, and weighed out to obtain 400 g of glass. Then, the mixed raw materials were put in a platinum crucible, put into an electric furnace at 1500° C. to 1700° C., melted for about 3 hours, defoamed, and homogenized. Klc of a glass material A was 0.8 (MPa·m^{1/2}).
Glass material A: 66% of SiO₂, 11% of Al₂O₃, 0.5% of Y₂O₃, 1.3% of ZrO₂, 11% of Li₂O, 5.5% of Na₂O, 1.5% of K₂O, 3% of MgO, and other components of 0.3%. A ratio (R₂O/Al₂O₃) of the total content of Li₂O, Na₂O, and K₂O to the content of Al₂O₃ is 1.6.
Glass material B: 65% of SiO₂, 16% of Al₂O₃, 1.2% of P₂O₅, 7.5% of Li₂O, 5% of Na₂O, 0.5% of K₂O, 0.5% of MgO, 1.3% of CaO, and 3% of B₂O₃. A ratio (R₂O/Al₂O₃) of the total content of Li₂O, Na₂O, and K₂O to the content of Al₂O₃ is 0.8.

Glass material C: 70% of SiO₂, 11.5% of Al₂O₃, 0.3% of P₂O₅, 9% of Li₂O, 2.5% of Na₂O, 0.2% of K₂O, 0.8% of MgO, 2.6% of CaO, 0.1% of ZrO₂, and 3% of B₂O₃. A ratio (R₂O/Al₂O₃) of the total content of Li₂O, Na₂O, and K₂O to the content of Al₂O₃ is 1.0.

The obtained molten glass was poured into a metal mold, held at a temperature which is approximately 50° C. higher than a glass transition point for 1 hour, and then cooled to the room temperature at a rate of 0.5° C./min, thereby obtaining a glass block. The obtained molten glass was poured into a mold, held at a temperature around the glass transition point (714° C.) for about 1 hour, and then cooled to the room temperature at the rate of 0.5° C./min, thereby obtaining a glass block.

The obtained glass block was cut, ground, and finally mirror-polished on both surfaces to obtain a glass sheet (glass for chemical strengthening) having a size of 120 mm×60 mm and a sheet thickness of 0.70 mm.

### <Chemical Strengthening Treatment and Evaluation of Chemically Strengthened Glass>

The glass sheet obtained in the above-described manner was immersed in the molten salt composition under conditions shown in Tables 1 and 2, subjected to the first ion exchange treatment and the second ion exchange treatment, and chemically strengthened glasses according to Examples 1 to 16 were obtained. Examples 1, 2, 5, 6, 13 to 15, 17, and 18 are working examples, and Examples 3, 4, 7 to 12, and 16 are comparative examples. The obtained chemically strengthened glasses were evaluated by the following methods.

### [Stress Measurement by Scattered Light Photoelastic Stress Meter]

A stress of the chemically strengthened glass was measured by the method described in WO2018/056121 using a scattered light photoelastic stress meter (SLP-2000 manufactured by Orihara Industrial Co., Ltd.). A stress profile was calculated using attached software [SlpV (Ver. 2019.11.07.001)] of the scattered light photoelastic stress meter (SLP-2000 manufactured by Orihara Industrial Co., Ltd.).

A function used for obtaining the stress profile is σ(x)=[a₁×erfc(a₂×x)+a₃×erfc (a₄×x)+a₅]. aᵢ(i=1 to 5) is a fitting parameter, and erfc is a complementary error function. The complementary error function is defined by the following expression.

$$\begin{matrix}erfc ( x ) = 1 - erf ( x ) \\ = \frac{2}{\sqrt{π}} {\int }_{x}^{∞} {e}^{- {t}^{2}} dt = {e}^{- {x}^{2}} erfc x ( x )\end{matrix} \qquad [ Formula 2 ]$$

In the evaluation in the present specification, the fitting parameter was optimized by minimizing a residual sum of squares of the obtained raw data and the above-described function. A measurement processing conditions was single, and regarding measurement region processing adjustment items, an edge method was designated for the surface, in which 6.0 μm was designated for an inner surface edge, automatic was designated for inner left and right edges, and automatic (center of the sample film thickness) for an inner deep edge, and a fitting curve was designated for extension of a phase curve to the center of a sample thickness.

The stress in the glass surface layer portion, which is several tens of μm or less from the glass surface, was measured using a film stress measurement (FSM6000-UV manufactured by Orihara Industrial Co., Ltd.) according to the methods described in WO2018/056121 and WO2017/115811.

At the same time, the concentration distribution (sodium ion, potassium ion, and lithium ion) of alkali metal ions in a cross-sectional direction was measured using an electron probe micro analyzer (EPMA), and it was confirmed that there was no contradiction with the obtained stress profile.

From the above-described measurement results and the obtained stress profile, values of K-CS₀, K-DOL, K-CSarea, Na-CS₀, Na-DOL, Na-CSarea, CS₁, CS₂, CS₅₀, CS₉₀, CTmax, CTave, and ICT were obtained. Results are shown in Tables 1 and 2.

### <Measurement of Resistivities>

The surface resistivity and the volume resistivity of the chemically strengthened glass in each example were measured using the following methods.

### Preparation of Glass Sample and Film Formation Step

A glass sample having a size of 120 mm×60 mm×0.7 mm was used. Before measuring the surface resistivity, film formation was performed using the following procedure. A film was formed on the glass sample having a size of 120 mm×60 mm×0.7 mm using a sputtering device. A platinum target was used as a target for film formation, and argon was introduced to form a platinum film of 30 nm on the glass surface. During film formation, patterning of a square of 60 mm was performed in accordance with JISR3256: 1998.

### Surface Resistivity

The surface resistivity was measured by the following method.

A measurement device used an ultra-microammeter.

The surface resistivity was measured by a three-terminal method in accordance with JIS C2141: 1992 and JIS R3256: 1998.

An applied voltage was 100 V, and the value was measured 180 seconds after voltage application. A discharge time was 3 seconds.

### Volume Resistivity

The volume resistivity was measured by the following method.

A measurement device used an ultra-microammeter.

The glass sample having a size of 120 mm×60 mm×0.7 mm was used.

Measurement was performed by a three-terminal method in accordance with JIS C2141: 1992 and JIS R3256: 1998.

An applied voltage was 100 V, and the value was measured 180 seconds after voltage application. A discharge time was 3 seconds.

Results are shown in Tables 1 and 2. FIG. 2 is a diagram showing the relationship between the surface resistivity and the volume resistivity for the chemically strengthened glass in each example. FIG. 3 is a diagram showing the relationship between the actually measured value of the volume resistivity and the value of Y for the chemically strengthened glass in each example.

The value of Y is defined by the following expression.

$$Y = - 0.5984 {x}_{1} + 0.00018 {x}_{2} + 4.319 \times {10}^{- 7} {x}_{3} + 8.5$$

x₁: concentration of LiNO₃ (mass %) in molten salt used in final ion exchange treatment during chemical strengthening treatment
x₂: product K-CSarea (Pa·m) of K-CS₀ and K-DOL
x₃: product Na-CSarea (Pa·m) of Na-CS₀ and Na-DOL
   <Concentration of K₂O, Concentration of Li₂O>

The concentration of K₂O at the depth of x (μm) and the concentration of Li₂O at the depth of x (μm) were measured using the above-described method. From the results, K₂O@3 μm, K₂O@center, Li₂O@5 μm, and Li₂O@center were obtained. The results are shown in Tables 1 and 2.

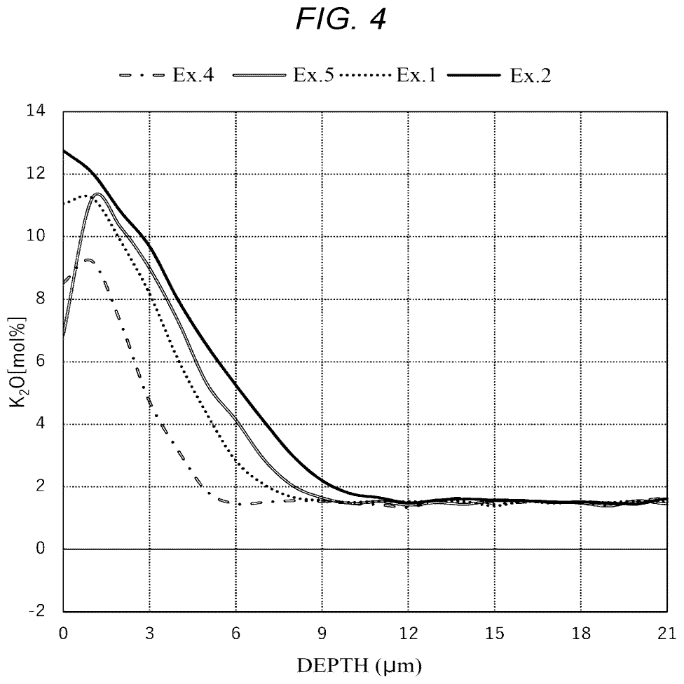

FIG. 4 shows K₂O profiles of the surface layers of Examples 1, 2, 4, and 5. As shown in FIG. 4, a concentration of the potassium ion at the depth of 3 μm from the surface layer changes in each sample, and as shown in Tables 1 and 2, it can be confirmed that there is a correlation between the potassium ion at the depth of 3 μm from the surface layer and the surface resistivity or the volume resistivity.

Terms in Tables 1 and 2 are described below.
K-CS₀: compressive stress value (MPa) caused by potassium ion at depth of 0 μm measured by FSM
K-DOL: value of depth (μm) from glass surface of compressive stress layer caused by potassium ion
K-CSarea: CS₀×K-DOL (Pa·m)
Na-CS₀: compressive stress value (MPa) caused by Na ion at depth of 0 μm measured by SLP
Na-DOL: value of depth (μm) from glass surface of compressive stress layer caused by sodium ion
Na-CSarea: Na-CS₀×Na-DOL (Pa·m)
CSₓ: compressive stress value (MPa) at depth of X μm
CTave=ICT/L_{CT} (MPa)
ICT: integrated value of tensile stress (Pa·m)
LCT: sheet thickness direction length (μm) of tensile stress region
CTmax: maximum tensile stress
K₂O@3 μm: concentration (mol %) of K₂O at depth of 3 μm from surface
K₂O@center: concentration (mol %) of K₂O at sheet thickness central portion
Li₂O@3 μm: concentration (mol %) of Li₂O at depth of 3 μm from surface
Li₂O@center: concentration (mol %) of Li₂O at sheet thickness central portion

TABLE 1

| | | | Ex. 1 | Ex. 2 | Ex. 3 | Ex. 4 | Ex. 5 |
|---|---|---|---|---|---|---|---|
| Glass material | | | A | A | A | A | A |
| Sheet Thickness | | (μm) | 700 | 700 | 700 | 700 | 700 |
| K1C | | (MPa · m½) | 0.8 | 0.8 | 0.8 | 0.8 | 0.8 |
| First ion | First molten | KNO₃ | 0 | 0 | 0 | 60 | 60 |
| exchange | salt | NaNO₃ | 100 | 100 | 100 | 40 | 40 |
| | composition | LiNO₃ | 0 | 0 | 0 | 0 | 0 |
| | (mass %) | | | | | | |
| | Temperature | (° C.) | 410 | 410 | 410 | 410 | 410 |
| | Time | (min) | 120 | 120 | 120 | 170 | 170 |
| Second | Second molten | KNO₃ | 99 | 99 | 99.3 | 99.3 | 99.3 |
| ion | salt | NaNO₃ | 1 | 1 | 0.6 | 0.6 | 0.6 |
| exchange | composition | LiNO₃ | 0 | 0 | 0.1 | 0.1 | 0.1 |
| | (mass %) | | | | | | |
| | Temperature | (° C.) | 440 | 440 | 390 | 390 | 390 |
| | Time | (min) | 60 | 240 | 60 | 60 | 240 |
| Property | K—CS₀ | (MPa) | 884 | 1066 | 900 | 934 | 904 |
| | K-DOL | (μm) | 6.3 | 11.7 | 2.0 | 3.7 | 4.6 |
| | K—CSarea | (Pa · m) | 5569 | 12472.2 | 1800 | 3456 | 4158 |
| | Na—CS₀ | (MPa) | 243 | 368 | 246 | 244 | 155 |
| | Na-DOL | (μm) | 127 | 127 | 119 | 121 | 139 |
| | Na—CSarea | (Pa · m) | 30861 | 46736 | 29274 | 29524 | 21545 |
| | CS₁ | (MPa) | 823 | 1054 | 0 | 679 | 760 |
| | CS₂ | (MPa) | 734 | 1036 | 0 | 424 | 581 |
| | CS₅₀ | (MPa) | 97 | 36 | 123 | 124 | 93 |
| | CS₉₀ | (MPa) | 42 | 17 | 43 | 45 | 47 |
| | CTMax | (MPa) | 82.2 | 69.9 | 69.7 | 79.1 | 78.9 |
| | CTave | (MPa) | 59 | 40 | 57 | 61 | 54 |
| | ICT | (Pa · m) | 26235 | 17753 | 26321 | 28106 | 22846 |
| | K₂O@3 μm | (mol %) | 8.2 | 9.7 | — | 4.7 | 9.0 |
| | K₂O@center | (mol %) | 1.5 | 1.5 | 1.5 | 1.5 | 1.5 |
| | K₂O@3 μm/K₂O@center | | 5.5 | 6.5 | — | 3.1 | 6.0 |
| | Li₂O@5 μm | (mol %) | 8 | — | — | 9 | 8.8 |
| | Li₂O@center | (mol %) | 10.4 | 10.4 | 10.4 | 10.4 | 10.4 |
| | Li₂O@5 μm/Li₂O@center | | 0.77 | — | — | 0.87 | 0.85 |
| | Volume | (logΩ cm) | 10.2 | 10.5 | 9.4 | 9.4 | 9.7 |
| | resistivity | | | | | | |
| | Surface | (logΩ/sq) | 11.3 | 11.5 | 10.7 | 10.8 | 11.3 |
| | resistivity | | | | | | |
| | Y | (logΩ cm) | 9.9 | 11.3 | 9.2 | 9.5 | 9.6 |

| | | | Ex. 6 | Ex. 7 | Ex. 8 | Ex. 9 |
|---|---|---|---|---|---|---|
| Glass material | | | A | A | A | A |
| Sheet Thickness | | (μm) | 700 | 700 | 700 | 700 |
| K1C | | (MPa · m½) | 0.8 | 0.8 | 0.8 | 0.8 |
| First ion | First molten | KNO₃ | 60 | 0 | 0 | 0 |
| exchange | salt | NaNO₃ | 40 | 100 | 100 | 99.5 |
| | composition | LiNO₃ | 0 | 0 | 0 | 0.5 |
| | (mass %) | | | | | |
| | Temperature | (° C.) | 410 | 410 | 410 | 410 |
| | Time | (min) | 170 | 30 | 120 | 120 |
| Second | Second | KNO₃ | 99.4 | — | — | — |
| ion | molten salt | NaNO₃ | 0.6 | — | — | — |
| exchange | composition | LiNO₃ | 0 | — | — | — |
| | (mass %) | | | | | |
| | Temperature | (° C.) | 390 | — | — | — |
| | Time | (min) | 60 | — | — | — |
| Property | K—CS₀ | (MPa) | 1109 | 0 | 0 | 0 |
| | K-DOL | (μm) | 4.3 | 0 | 0 | 0 |
| | K—CSarea | (Pa · m) | 4769 | 0 | 0 | 0 |
| | Na—CS₀ | (MPa) | 275 | 345 | 330 | 311 |
| | Na-DOL | (μm) | 118 | 69 | 103 | 101 |
| | Na—CSarea | (Pa · m) | 32450 | 23805 | 33990 | 31411 |
| | CS₁ | (MPa) | 850 | 0 | 0 | 0 |
| | CS₂ | (MPa) | 591 | 0 | 0 | 0 |
| | CS₅₀ | (MPa) | 130 | 52 | 133 | 123 |
| | CS₉₀ | (MPa) | 43 | −26 | 23 | 19 |
| | CTMax | (MPa) | 82.7 | 39.1 | 71.3 | 66.3 |
| | CTave | (MPa) | 63 | 37 | 61 | 57 |
| | ICT | (Pa · m) | 29365 | 20632 | 30316 | 28522 |
| | K₂O@3 μm | (mol %) | — | — | — | — |
| | K₂O@center | (mol %) | 1.5 | 1.5 | 1.5 | 1.5 |
| | K₂O@3 μm/K₂O@center | | — | — | — | — |
| | Li₂O@5 μm | (mol %) | — | — | — | — |
| | Li₂O@center | (mol %) | 10.4 | 10.4 | 10.4 | 10.4 |
| | Li₂O@5 μm/Li₂O@center | | — | — | — | — |
| | Volume | (logΩ cm) | 9.9 | 8.7 | 8.7 | 8.7 |
| | resistivity | | | | | |
| | Surface | (logΩ/sq) | 11.1 | 10.1 | 10.1 | 10.1 |
| | resistivity | | | | | |
| | Y | (logΩ cm) | 9.8 | 8.8 | 8.8 | 8.8 |

TABLE 2

| | | | Ex. 10 | Ex. 11 | Ex. 12 | Ex. 13 | Ex. 14 |
|---|---|---|---|---|---|---|---|
| Glass material | | | A | A | A | A | A |
| Sheet Thickness | | (μm) | 700 | 700 | 700 | 700 | 700 |
| K1C | | (MPa · m½) | 0.8 | 0.8 | 0.8 | 0.8 | 0.8 |
| First ion | First molten | KNO₃ | 60 | — | — | — | — |
| exchange | salt | NaNO₃ | 40 | — | — | — | — |
| | composition | LiNO₃ | 0 | — | — | — | — |
| | (mass %) | | | | | | |
| | Temperature | (° C.) | 410 | — | — | — | — |
| | Time | (min) | 170 | — | — | — | — |
| Second ion | Second | KNO₃ | — | 99.5 | 99.3 | 99 | 100 |
| exchange | molten salt | NaNO₃ | — | 0 | 0.6 | 1 | 0 |
| | composition | LiNO₃ | — | 0.5 | 0.1 | 0 | 0 |
| | (mass %) | | | | | | |
| | Temperature | (° C.) | — | 440 | 390 | 440 | 440 |
| | Time | (min) | — | 60 | 60 | 60 | 60 |
| Property | K—CS₀ | (MPa) | 600 | 796 | 932 | 902 | 969 |
| | K-DOL | (μm) | 1.0 | 4.0 | 2.5 | 6.0 | 6.1 |
| | K—CSarea | (Pa · m) | 600 | 3184 | 2330 | 5412 | 5911 |
| | Na-CS₀ | (MPa) | 347 | 128 | 87 | 203 | 189 |
| | Na-DOL | (μm) | 107 | 27 | 60 | 78 | 45 |
| | Na—CSarea | (Pa · m) | 37129 | 3456 | 5220 | 15834 | 8505 |
| | CS₁ | (MPa) | 0 | 669 | 564 | 859 | 938 |
| | CS₂ | (MPa) | 0 | 513 | 195 | 781 | 855 |
| | CS₅₀ | (MPa) | 132 | −6 | 5 | 13 | −2 |
| | CS₉₀ | (MPa) | 27 | −6 | −7 | −4 | −9 |
| | CTMax | (MPa) | 80.8 | 5.9 | 9.2 | 22.0 | 15.4 |
| | CTave | (MPa) | 64 | 6 | 9 | 18 | 13 |
| | ICT | (Pa · m) | 31315 | 3784 | 4944 | 9869 | 7979 |
| | K₂O@3 μm | (mol %) | — | — | — | — | — |
| | K₂O@center | (mol %) | 1.5 | 1.5 | 1.5 | 1.5 | 1.5 |
| | K₂O@3 μm/K₂O@center | | — | — | — | — | — |
| | Li₂O@5 μm | (mol %) | — | — | — | — | — |
| | Li₂O@center | (mol %) | 10.4 | 10.4 | 10.4 | 10.4 | 10.4 |
| | Li₂O@5 μm/Li₂O@center | | — | — | — | — | — |
| | Volume | (logΩ cm) | 8.8 | 9.0 | 9.0 | 10.1 | 10.2 |
| | resistivity | | | | | | |
| | Surface | (logΩ/sq) | 10.1 | — | 10.3 | 11.2 | 11.3 |
| | resistivity | | | | | | |
| | Y | (logΩ cm) | 8.9 | 9.4 | 9.3 | 9.9 | 10.0 |

| | | | Ex. 15 | Ex. 16 | Ex 17 | Ex. 18 |
|---|---|---|---|---|---|---|
| Glass material | | | A | A | B | C |
| Sheet Thickness | | (μm) | 700 | 700 | 700 | 700 |
| K1C | | (MPa · m½) | 0.8 | 0.8 | 0.81 | 0.82 |
| First ion | First molten | KNO₃ | 60 | — | 50 | 20 |
| exchange | salt | NaNO₃ | 40 | — | 50 | 80 |
| | composition | LiNO₃ | 0 | — | 0 | 0 |
| | (mass %) | | | | | |
| | Temperature | (° C.) | 410 | — | 440 | 410 |
| | Time | (min) | 170 | — | 95 | 360 |
| Second ion | Second | KNO₃ | 100 | — | 100 | 100 |
| exchange | molten salt | NaNO₃ | 0 | — | 0 | 0 |
| | composition | LiNO₃ | 0 | — | 0 | 0 |
| | (mass %) | | | | | |
| | Temperature | (° C.) | 390 | — | 390 | 390 |
| | Time | (min) | 60 | — | 30 | 180 |
| Property | K—CS₀ | (MPa) | 1215 | 0 | 1100 | 1010 |
| | K-DOL | (μm) | 4.2 | 0 | 4.5 | 4.6 |
| | K—CSarea | (Pa · m) | 5103 | 0 | 4950 | 4646 |
| | Na—CS₀ | (MPa) | 265 | 0 | 255 | 270 |
| | Na-DOL | (μm) | 120 | 0 | 129 | 144 |
| | Na—CSarea | (Pa · m) | 31800 | 0 | 32895 | 38880 |
| | CS₁ | (MPa) | 923 | 0 | 920 | 789 |
| | CS₂ | (MPa) | 631 | 0 | 690 | 570 |
| | CS₅₀ | (MPa) | 125 | 0 | 130 | 119 |
| | CS₉₀ | (MPa) | 42 | 0 | 54 | 64 |
| | CTMax | (MPa) | 81.3 | 0 | 90.0 | 109.0 |
| | CTave | (MPa) | 62 | 0 | 65 | 70 |
| | ICT | (Pa · m) | 28394 | 0 | 28800 | 29000 |
| | K₂O@3 μm | (mol %) | — | 1.5 | 3.3 | 1.2 |
| | K₂O@center | (mol %) | 1.5 | 1.5 | 0.5 | 0.2 |
| | K₂O@3 μm/K₂O@center | | — | 1 | 6.6 | 6.0 |
| | Li₂O@5 μm | (mol %) | — | 10.4 | 6.2 | 7.2 |
| | Li₂O@center | (mol %) | 10.4 | 10.4 | 7.5 | 9.0 |
| | Li₂O@5 μm/Li₂O@center | | — | 1 | 0.83 | 0.80 |
| | Volume | (logΩ cm) | 10.2 | 8.5 | 10 | 10.5 |
| | resistivity | | | | | |
| | Surface | (logΩ/sq) | 11.3 | — | 11.0 | 11.5 |
| | resistivity | | | | | |
| | Y | (logΩ cm) | 9.8 | 8.8 | 9.4 | 9.4 |

As shown in Tables 1 and 2, compared with comparative examples, each of Examples 1, 2, 5, 6, 13 to 15, 17, and 18 in which K-DOL is 4.2 μm or more has a larger surface resistivity, that is, 11 [log Ω/sq] or more.

Compared with comparative examples, each of Examples 1, 2, 5, 6, 13 to 15, 17, and 18 in which K-CSarea is 4000 Pa·m or more has a larger surface resistivity, that is, 11 [log Ω/sq] or more.

Compared with comparative examples, each of Examples 1, 2, 5, 17, and 18 in which the ratio of K₂O@3 μm, which is the concentration of K₂O at the depth of 3 μm from the glass surface, to K₂O@center, which is the concentration of K₂O at the sheet thickness central portion, is 5.5 or more has a larger surface resistivity, that is, 11 [log Ω/sq] or more.

Compared with comparative examples, each of Examples 1, 5, 17, and 18 in which the ratio of Li₂O@5 μm, which is the concentration of Li₂O at the depth of 5 μm from the glass surface, to Li₂O@center, which is the concentration of Li₂O at the sheet thickness central portion, is 0.85 or less has a larger surface resistivity, that is, 11 [log Ω/sq] or more.

The present invention has been described in detail with reference to a specific mode, but it will be apparent to those skilled in the art that various changes and modifications can be made without departing from the spirit and scope of the present invention.

The present application is based on Japanese Patent Application No. 2023-075767 filed on May 1, 2023 and Japanese Patent Application No. 2024-071340 filed on Apr. 25, 2024, and the entirety of which is incorporated herein by reference.

### REFERENCE SIGNS LIST

10 OLED display
11 Cover glass
12 Charges
13 OLED light emitting element
14 Polyimide substrate
15 Negative electrode
16 TFT array

What is claimed is:

1. A glass for chemical strengthening, comprising:
in terms of mole percentage based on oxides,
50% or more of SiO₂;
0% to 10% of B₂O₃;
1% to 30% of Al₂O₃;
0% to 10% of P₂O₅;
0% to 10% of Y₂O₃;
0% to 25% of Li₂O;
0% to 25% of Na₂O;
0% to 25% of K₂O;
0% to 10% of MgO;
0% to 10% of CaO;
0% to 10% of SrO;
0% to 10% of BaO;
0% to 10% of ZnO;
0% to 5% of ZrO₂;
0% to 5% of TiO₂;
0% to 5% of SnO₂; and
0% to 0.5% of Fe₂O₃, wherein a ratio (R₂O/Al₂O₃) of a total content of Li₂O, Na₂O, and K₂O to a content of Al₂O₃ satisfies the following Expression (A):
0.8≤(R₂O/Al₂O₃)≤30 (A).

2. The glass for chemical strengthening according to claim 1, further comprising:
in terms of mole percentage based on oxides,
7% to 12% of Li₂O;
1.5% to 6% of Na₂O; and
0% to 1.5% of K₂O.

3. A chemically strengthened glass, wherein
K-DOL defined below is 4.2 μm or more, and
a surface resistivity is 11 [log Ω/sq] or more,
K-DOL (μm): value of depth from glass surface of compressive stress layer caused by potassium ion.

4. The chemically strengthened glass according to claim 3, wherein
K-CSarea defined below is 4000 Pa·m or more, and
a surface resistivity is 11 [log Ω/sq] or more,
K-CSarea (Pa·m): product of K-CS₀ and K-DOL,
K-CS₀ (MPa): compressive stress value on glass surface measured by film stress measurement,
K-DOL (μm): value of depth from glass surface of compressive stress layer caused by potassium ion.

5. The chemically strengthened glass according to claim 4, wherein
the K-CS₀ is 800 MPa or more.

6. The chemically strengthened glass according to claim 3, wherein
a ratio of K₂O@3 μm, which is a concentration of K₂O at a depth of 3 μm from a glass surface, to K₂O@center, which is a concentration of K₂O at a sheet thickness central portion, is 5.5 or more, and a surface resistivity is 11 [log Ω/sq] or more.

7. The chemically strengthened glass according to claim 3, wherein a ratio of Li₂O@5 μm, which is a concentration of Li₂O at a depth of 5 μm from a glass surface, to Li₂O@center, which is a concentration of Li₂O at a sheet thickness central portion, is 0.85 or less, and
a surface resistivity is 11 [log Ω/sq] or more.

8. The chemically strengthened glass according to claim 3, wherein
a value of Y defined below is 9.4 or more,
$$Y = 0 \text{.00018} {x}_{1} + 4.319 \times {10}^{- 7} {x}_{2} + 8.5 ,$$
x₁: product K-CSarea (Pa·m) of K-CS₀ and K-DOL,
x₂: product Na-CSarea (Pa·m) of Na-CS₀ and Na-DOL,
K-CS₀ (MPa): compressive stress value on glass surface measured by film stress measurement,
K-DOL (μm): value of depth from glass surface of compressive stress layer caused by potassium ion,
Na-CS₀ (MPa): compressive stress value on glass surface measured by scattered light photoelastic stress meter,
Na-DOL (μm): value of depth from glass surface of compressive stress layer caused by Na ion.

9. An electronic device, comprising:
the glass for chemical strengthening according to claim 1.

10. An electronic device, comprising:
the chemically strengthened glass according to claim 3.
